(19) United States
(12) Patent Application Publication
(10) Pub. No.: US 2013/0071629 A1
(43) Pub. Date: Mar. 21, 2013

(54) METHOD OF APPLYING A LUBRICANT TO A MICROMECHANICAL DEVICE

(71) Applicants: Sujeet Kumar Sinha, Singapore (SG); Jonathan Yonghui Leong, Singapore (SG); Satyanarayana Nalam, Singapore (SG); Hongbin Yu, Singapore (SG); Harikumar Vijayan, Singapore (SG); Guangya Zhou, Singapore (SG)

(72) Inventors: Sujeet Kumar Sinha, Singapore (SG); Jonathan Yonghui Leong, Singapore (SG); Satyanarayana Nalam, Singapore (SG); Hongbin Yu, Singapore (SG); Harikumar Vijayan, Singapore (SG); Guangya Zhou, Singapore (SG)

(73) Assignee: National University of Singapore, Singapore (SG)

(21) Appl. No.: 13/634,549

(22) PCT Filed: Mar. 17, 2011
(86) PCT No.: PCT/SG2011/000104

§ 371 Date: Nov. 21, 2012

Related U.S. Application Data
(60) Provisional application No. 61/314,627, filed on Mar. 17, 2010.

(51) Int. Cl. B05D 5/00; B05C 5/00; C10M 107/32

(52) U.S. Cl. CPC B05D 5/00; C10M 107/32; B05C 5/00
USPC 428/194; 428/195.1; 427/372.2; 427/256; 118/300

(57) ABSTRACT

According to an embodiment of the present invention, a method of applying a lubricant to a micromechanical device is provided. The method includes: positioning a dispensing portion of a lubricant liquid dispenser over a surface portion of a micromechanical device; and controlling the dispenser such that a single lubricant liquid droplet of a predefined volume is forced out of the dispensing portion and impinges onto the surface portion.

### FIELD

The invention relates to a method of applying a lubricant to a micromechanical device.

### BACKGROUND

As the size of a device decreases to micro and nano scales, interactive surface forces between components become critical in Micro-Electro-Mechanical Systems (MEMS) and Nano-Electro-Mechanical Systems (NEMS).

MEMS comprise micron scale fabricated mechanical and electrical components. Due to their small scale, a problem occurs in those surfaces adhere upon contact, due to interactive forces that become significant at the micro scale, rendering the device immoveable and useless. These adhesive forces are known as “stiction”. At the micro-scale, the surface properties that affect the adhesion between surfaces are surface energies, roughness, chemical nature, electrostatic and van der Waals forces, which increase as the size of the devices and components decrease. As a result of these adhesive forces, the surfaces of the components stick to each other either permanently or temporarily, thus resulting in “stiction”.

Thus, MEMS components are commonly fabricated such that any possibility of stiction between the surfaces is avoided. However, this limits the design and application possibilities of such devices. Some examples of MEMS devices that experience issues with stiction include RF switches, gears, and accelerometers.

One known technique to combat stiction induced failures between surfaces is the imprinting of textures on the surfaces. Due to the textures, the effective contact area is reduced which makes it possible to lower the interfacial forces which cause stiction. However, although this technique may be efficient for modifying large surfaces like top surfaces of MEMS devices, it may not be practical for modifying small surfaces like sidewalls of MEMS devices or surfaces which are difficult to access.

Another approach to reduce stiction is to use a liquid lubrication system that creates a lubricant vapour, and lubricates the surface of the MEMS device by exposing the relevant surfaces to the lubricant vapour using a carrier gas such as nitrogen. However, vapour deposition usually does not result in good bonding between the lubricant and the surface, thus preventing long term durability of lubricant surface modifications. Further, the resultant films are also usually too thin to significantly modify the surface properties and avoid the occurrence of “in-use stiction” or “release stiction”. As a consequence, friction and wear cannot be avoided. Also, thin lubricant films are likely to be displaced, damaged, or even removed due to the impact of contact or wear against the two surfaces (“In-use” stiction refers to stiction occurring while the device is in operation, in storage or improperly handled. “Release stiction” refers to stiction resulting from the capillary forces of the liquid etchants used when etching the device). Also, it is difficult to prevent vapour from depositing over the entire surface of the device, i.e. to confine the vapour deposition to dedicated surface areas. Thus, it is difficult to prevent unintentional vapor deposition into areas of the device affecting the functionality of the device in a negative way. Research [“A Nano- to Macroscale Tribological Study of PFTS and TCP Lubricants for Si MEMS Applications” by Miller et. al, Tribol Lett (2010) 38:69-78] has shown that although vapour deposition of particular lubricants improves the wear life of silicon surfaces in MEMS, the wear life also is insufficient for extended usage and would fail within hundreds of cycles.

There is thus a need to provide a method of applying lubricant to a micromechanical device that addresses the above problems.

### SUMMARY OF THE INVENTION

According to an embodiment of the present invention, a method of applying a lubricant to a micromechanical device is provided. The method includes: positioning a dispensing portion of a lubricant liquid dispenser over a surface portion of a micromechanical device; and controlling the dispenser such that a single lubricant liquid droplet of a predefined volume is forced out of the dispensing portion and impinges onto the surface portion.

One effect of this embodiment is that lubrication of micromechanical devices is achieved, thereby reducing the undesired effect of stiction. Compared to prior art lubricating methods that distribute a layer of lubricant by flooding an entire surface of a micromechanical device with lubricant, this embodiment allows more controlled lubrication, i.e. it is possible to only lubricate selected portions of a surface of a micromechanical device. By only lubricating selected areas or portions of a micromechanical device surface, it can be avoided that lubricant is deposited onto electronic circuitry or comb drives that may be integrated within the micromechanical device (which may occur in prior art lubricating methods that flood an entire surface of a micromechanical device).

The term “lubricant liquid dispenser” may mean a structure serving to store and provide access to lubricant liquid and to release the fluid on demand through a dispensing portion. In one embodiment, the lubricant liquid dispenser may include a syringe, the syringe being connected to the dispensing portion. In another embodiment, the lubricant liquid dispenser may include a fluid supply reservoir, the reservoir being connected to the dispensing portion via a tubing.

In the context of the present invention, the term “dispensing portion” may refer to any structure that acts as a conduit having an opening allowing fluid to flow out of the lubricant liquid dispenser. The dispensing portion may be integral with the lubricant liquid dispenser. On the other hand, the dispensing portion may be a portion detachably connected to the lubricant liquid dispenser such that the dispensing portion and the lubricant liquid dispenser are separate components. In one embodiment where the dispensing portion and the lubricant liquid dispenser are separate components, the lubricant liquid dispenser may be disposed at a distance away from the surface portion. The dispensing portion may be connected to the lubricant liquid dispenser via tubing, the tubing allowing fluid flow between the lubricant liquid dispenser and the dispensing portion. In this manner, fluid from the lubricant liquid dispenser is allowed to reach the surface portion of the micromechanical device. In one embodiment, the dispensing portion may include a needle having a needle tip, the opening of the dispensing portion being formed at the needle tip. A channel may be formed within the needle, the channel guiding fluid (such as lubricant liquid) from the lubricant liquid dispenser to the needle tip. In another embodiment, the dispensing portion may be a capillary tube within which a channel is established, to allow lubricant liquid to flow. The tip of the capillary tube comprises an opening to allow the lubricant liquid to exit.

The term “micromechanical device” may mean a semiconductor wafer or substrate having micro-sized or smaller structures fabricated thereon or therein using techniques such as optical lithography, doping, metal sputtering, oxide deposition, and plasma etching which have been developed for the fabrication of integrated circuits. Typical structures include actuating portions such as accelerometers, pressure sensors, micro-motors, micro-gears and micromirrors, etc. These actuating portions are disposed in openings formed within the semiconductor wafer or substrate such that there is a gap between the actuating portions and sidewalls of the opening. In addition, the semiconductor wafer or substrate may include integrated circuitry that drives the actuating portions or electronics micro-fabricated or nano-fabricated thereon. The circuitry may for example provide processing functions such as AND, NAND, or OR logic using transistors, resistors, capacitors, inductors and the like. The circuitry may serve for any purpose, for example be usable as a Radio Frequency Identification Tag. The entire micromechanical device may be placed in a sealed package.

The term “surface portion” means a part or several parts of the overall surface of the semiconductor wafer or substrate of the MEMS device. For example, “surface portion” may include portions of the surface of the semiconductor wafer or substrate where the actuating portions of the micromechanical device reside.

In one embodiment, the lubricant liquid may include a mixture of a lubricant and a solvent. The lubricant liquid may also include further additives that improve the durability of the lubricant eventually applied onto the surface portion of the micromechanical device. Examples of such additives include PFPE (perfluoropolyether)-soluble phosphates [such as phosphazine (X-1P)], PFPE-soluble carboxylic acid and Fomblin DA additives.

The lubricant may be a chemical substance that lubricates the surface portion of the micromechanical device to prevent stiction. The lubricant may have low surface tension and low contact angle, enabling the lubricant to spread evenly across topographies and providing a hydrophobic property. The lubricant may also have good chemical and thermal stability properties which minimize degradation under use and has high adhesion to the semiconductor substrate via organo-functional bonds. The lubricant may also provide a semi-hydrophobic to hydrophobic property, which is known to improve friction and wear properties, to the surface portion the lubricant is applied to Examples of chemical substances used for the lubricant include any one or more of fluorine based nanolubricants, self-assembled monolayers or ionic liquid lubricants. Examples of the fluorine based nanolubricants include any one or more of the chemicals fomblin Z, Zdiac, Z-tetraol, pentafluorophenyltriethoxysilane (PFPTES), fluorinert or AZ0H. Examples of the self-assembled monolayers include any one or more of the chemicals OTS (octadecyltrichlorosilane) or PFTS (1H,1H,2H,2H-perfluorodecyltrichlorosilane). Examples of the ionic liquid lubricants comprise any one or more of the chemicals penzane 2000 or 1-ethyl-3-hexylimidazolium tetrafluoroborate (L206). If PFPE is used as lubricant, it may be of the type having a non-polar (Z-15) and polar (Z-DOL) surface terminal groups.

The lubricant may be mixed with a solvent, and the mixture of lubricant and solvent may then be applied to a desired surface portion. Preferably, the solvent combines with the lubricant to form a mixture that is stable over an extended period of time. In one embodiment, the solvent may be a chemical substance, provided in liquid form to dissolve the lubricant, so that the lubricant liquid may be a solution being a mixture of the lubricant and the solvent. In another embodiment, the lubricant may be immiscible in the solvent, whereby the solvent acts as a carrier for the lubricant to allow the lubricant to be deposited onto the surface portion of the micromechanical device by injecting the mixture of the lubricant and the solvent onto the surface portion of the micromechanical device. The solvent may be a chemical substance that evaporates (at room temperature or at a higher temperature) such that only the lubricant remains after evaporation of the solvent.

An example of an organic solvent is ethers such as tetrahydrofuran (THF) and tert-butyl methyl ether (MTBE). Examples of other chemical substances that may be used as the solvent include any one or more of H-Galden.

In one embodiment, the lubricant may be present in the lubricant liquid in a concentration range of from between 0.2 wt % and 4.0 wt %. Preferably, the concentration of lubricant in the lubricant liquid is 4.0 wt %.

In one embodiment, in positioning the dispensing portion of the lubricant liquid dispenser over the surface portion of a micromechanical device, it may be the dispensing portion of the lubricant liquid dispenser that is moved, while the micromechanical device remains stationary. In another embodiment, in positioning the dispensing portion of the lubricant liquid dispenser over the surface portion of a micromechanical device, it may be the micromechanical device that is moved, while the dispensing portion of the lubricant liquid dispenser remains stationary. In another embodiment, in positioning the dispensing portion of the lubricant liquid dispenser over the surface portion of a micromechanical device, both the dispensing portion of the lubricant liquid dispenser and the micromechanical device may be moved relative to each other. The dispensing portion of the lubricant liquid dispenser may be placed directly over and in close proximity (i.e. adjacent and almost in contact) to the surface portion of the micromechanical device.

Controlling of the dispenser such that a single lubricant liquid droplet of a predefined volume is forced out of the dispensing portion may be achieved by, for example, pressure being applied to the lubricant liquid, subjecting the lubricant liquid to a vacuum force or a combination of applying pressure and vacuum force. A corresponding pressure source or vacuum source may be located at the lubricant liquid dispenser or at the dispensing portion. By only ejecting a single lubricant liquid from the dispensing portion, it is possible to have only the selected surface portion of the micromechanical device impinged by the lubricant liquid. The spread of lubricant liquid over the portion of the surface of the micromechanical device is thereby controlled and flooding is minimised, so that other surface portions (such as integrated circuitry) of the micromechanical device are not coated with the lubricant liquid. Further, by only using a single lubricant liquid droplet, only a small amount of lubricant liquid is required, compared to vapour deposition techniques, which uses more, as the lubricant has to be first converted to vapour form. The size of the volume of the of “predefined volume” may depend on several factors such as the size of the surface portion of the micromechanical device which is to be lubricated, the magnitude of the force applied to force out the single lubricant liquid droplet, the size of the opening of the dispensing portion of the lubricant liquid dispenser. Values for the predefined volume may for example range between 0.1 μl and 0.2 μl.

In one embodiment, the pressure applied to the lubricant liquid in order to force the single lubricant liquid droplet out of the dispensing portion may range between 0.08 MPa and 0.1 MPa. The pressure may be applied to the lubricant liquid in the form of a shot of air impacting the lubricant liquid.

In one embodiment, after having applied a pressure force to the lubricant liquid in order to force the single lubricant liquid droplet out of the dispensing portion, a vacuum force is applied to the lubricant liquid in order to prevent that, apart from the single lubricant liquid droplet, no further lubricant liquid is forced out of the dispensing portion.

In one embodiment, the positioning of the dispensing portion with respect to the surface of the micromechanical device is monitored using a microscope. In one embodiment, a video imaging system may be provided to further facilitate monitoring of the positioning of the dispensing portion. Through the microscope and the video imaging system, it can also be visually confirmed that lubricant liquid is applied to the surface portion of the micromechanical device.

In one embodiment, when forcing the lubricant liquid droplet out of the dispensing portion, a distance between the dispensing portion and the surface of the micromechanical device ranges between 0.5 mm and 3 mm. In one embodiment, the maximum distance may be 3 mm.

In the embodiment where the dispensing portion includes a needle having a needle tip and a channel formed within the needle, the lubricant liquid flows through the channel to the needle tip to be ejected at the needle tip, when pressure is applied to the lubricant liquid. After applying a pressure force to the lubricant liquid to force the single lubricant liquid droplet out of the needle tip, a vacuum force may be applied to the lubricant liquid to prevent, apart from the single lubricant liquid droplet, further lubricant liquid being forced out of the needle. A microscope or a video imaging system may be used to monitor the positioning of the needle with respect to the surface of the micromechanical device. Further, when forcing the lubricant liquid droplet out of the needle tip, a distance between the needle tip and the surface of the micromechanical device may range between 0.5 mm and 3 mm. It will be appreciated that in using a needle, lubrication of the selected surface portion (e.g. the actuating portions) of the micromechanical device can be done in a more precise manner.

In one embodiment, a diameter of the lubricant liquid channel at the needle tip may range between 60 μm and 80 μm. In another embodiment, the diameter should preferably be no larger than 80 μm.

In one embodiment, the volume of the single lubricant liquid droplet may be between 0.1 μl and 0.2 μl.

In one embodiment, a longitudinal axis of the needle is aligned relative to the surface portion of the micromechanical device at an angle ranging between 30° and 90°. In one embodiment, the longitudinal axis of the needle is preferably substantially perpendicular to the surface portion of the micromechanical device. The term “longitudinal axis” refers to an axis parallel to the channel formed in the needle. There is no contact between the needle and the surface portion of the micromechanical device, and the angle refers to the acute angle formed from extending the longitudinal axis to intersect the surface portion of the micromechanical device.

In one embodiment, the dispensing portion of the lubricant liquid dispenser may be positioned over an actuating portion or a gap portion of the micromechanical device. The term “gap” may refer to space between actuating portions of the micromechanical device and sidewalls of an opening formed within the semiconductor wafer or substrate, within which the actuating portions are located.

According to an embodiment of the present invention, a method of applying a lubricant to a micromechanical device may further include drying the surface portion of the micromechanical device, the surface portion having the predefined volume of the lubricant liquid provided thereon.

In one embodiment, the drying may be carried out such that lubricant from the lubricant liquid remains on the surface portion after drying the surface portion. In this manner, the solvent in the lubricant liquid evaporates, leaving the lubricant as on the surface portion of the micromechanical device.

In one embodiment, drying may be performed by exposing the surface portion to heat for about between 30 mins and 1 h at a temperature of between 80° C. and 120° C.

In another embodiment where no heat is applied, the drying may be performed by exposing, at room temperature, the surface portion for between 36 h and 50 h. Preferably, the drying at room temperature may be performed for between 40 and 48 hours.

In one embodiment where the lubricant liquid constitutes only lubricant in a liquid form, there will be no evaporation of solvent. Rather, drying the surface portion of the micromechanical device serves to cause the lubricant to form a dry film over the surface portion of the micromechanical device.

In one embodiment, the pressure force and the vacuum force are applied such that a single lubricant liquid droplet having the predefined volume breaks free from the dispensing portion before impinging onto the surface portion of the micromechanical device. In the context of the present invention, the term “breaks free” may mean that the single lubricant liquid droplet completely detaches from the dispensing portion before there is any contact of the single lubricant liquid droplet with the surface portion of the micromechanical device. In one embodiment, backflow vacuum is used to force the single lubricant liquid droplet to break free from the dispensing portion. The backflow vacuum applied on the lubricant liquid prevents constant flow of lubricant liquid onto the micromechanical device, which is undesired. The strength of the backflow vacuum applied to prevent constant or continuous flow varies and may depend on the viscosity of the lubricant and the diameter of the lubricant liquid channel formed in the dispensing portion. Parameters of a dispensing mechanism are optimized to allow the dispensing and detachment of a single lubricant liquid droplet to fall on the device, without the droplet suspending from the dispensing portion at the point of contact with the micromechanical device. A sample set of optimized parameters may be an overall pressure range of 80-100 kPa applied to the lubricant liquid for a diameter range of between 60 μm and 80 μm of the lubricant liquid channel of the dispensing portion of the dispensing mechanism. With optimized parameters, the volume of the single lubricant liquid droplet is calibrated and limited to ensure that overflow, if any, does not affect actuating portions of the micromechanical device or any other part of the micromechanical device. In optimizing parameters for the dispensing mechanism, it is preferable to adjust the pressure and the vacuum force used. However, other parameters in the dispensing mechanism such as the diameter of the needle and volume of the syringe (in an embodiment where the dispensing portion includes a needle and a lubricant liquid dispenser includes a syringe) may be changed. It is preferable for the diameter of the needle to be kept as fine as possible to provide more accurate dispensation of lubricant.

A net pressure is applied as a shot to eject the lubricant liquid onto the desired location, without suspension of the lubricant liquid from the tip of the dispensing portion. At no point of dispensation does the single lubricant liquid droplet contact both the dispensing portion and the micromechanical device at the same time. Avoiding droplet contact with both the dispensing portion and the micromechanical device is necessary as surface tension and viscous forces of the solvent are enough to cause the contacted component to adhere to the dispensing portion. Withdrawal of the dispensing portion may then cause the contacted component to break away from the micromechanical device.

According to an embodiment of the present invention, a method of applying a lubricant to a micromechanical device may further include using markers to denote where lubricant liquid dispensed from the dispensing portion lands. The surface portion of the micromechanical device is then aligned with the markers when positioning the dispensing portion of the lubricant liquid dispenser over the surface portion of the micromechanical device.

One effect of this embodiment is that it facilitates calibration of methods in accordance with embodiments of the invention, before lubricating a micromechanical device.

According to an embodiment of the present invention, a lubricant application system may be provided. The lubricant application system may include: a lubricant liquid dispenser having a dispensing portion configured to be adjustable relative to a surface portion of a micromechanical device; and a dispenser controller configured to control the dispenser such that a single lubricant liquid droplet of a predefined volume is forced out of the dispensing portion to impinge onto the surface portion.

In one embodiment, the dispenser controller may be adapted to apply a pressure force to the lubricant liquid in order to force the single lubricant liquid droplet out of the dispensing portion. The dispenser controller may also be adapted to apply a vacuum force to the lubricant liquid in order to prevent that, Lapart from the single lubricant liquid droplet, no further lubricant liquid is forced out of the dispensing portion.

In one embodiment, the pressure force and the vacuum force may be balanced such that the forced out single lubricant liquid droplet having the predefined volume breaks free from the dispensing portion before impinging onto the surface portion of the micromechanical device.

According to an embodiment of the present invention, the lubricant application system may further include a microscope to monitor the positioning of the dispensing portion with respect to the surface of the micromechanical device.

In one embodiment, the dispensing portion may include a needle having a needle tip; and a lubricant liquid channel formed within the needle to guide the lubricant liquid to the needle tip.

In one embodiment, a diameter of the lubricant liquid channel at the needle tip may range between 60 μm and 80 μm.

In one embodiment, the dispenser controller includes an air pressure unit. The air pressure unit may be capable of delivering shots of air.

According to an embodiment of the present invention, the lubricant application system may further include a movable stage to carry the micromechanical device.

According to an embodiment of the present invention, there may be provided a micromechanical device having lubricant applied using any one of the methods in accordance to embodiments of the invention.

In one embodiment, the lubricant may include fluorine in a concentration range of around 3.0 wt % or more.

According to an embodiment of the present invention, a micromechanical device may be provided. The micromechanical device may include an actuating portion, or a gap portion. The actuating portion or the gap portion may have a coat of lubricant, the coat of lubricant confined to an area of between 3 mm² and 4 mm² on the surface of the micromechanical device.

All embodiments described above in conjunction with the method of applying a lubricant to a micromechanical device may also be applied to the embodiments of the lubricant application system.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a flow chart illustrating a method, according to one embodiment of the present invention, of applying a lubricant to a micromechanical device.

FIG. 2 shows a flow chart illustrating a method, according to one embodiment of the present invention, of applying a lubricant to a micromechanical device.

FIG. 3 shows a flow chart illustrating a method, according to one embodiment of the present invention, of applying a lubricant to a micromechanical device.

FIG. 4 shows a schematic representation of a lubricant application system according to an embodiment of the invention.

FIG. 5 shows a schematic representation of a needle aligned relative to a surface portion of a micromechanical device to be lubricated.

FIG. 6 shows a perspective view of a portion of a micromechanical device.

FIGS. 7A and 7B both show a needle of a lubricant application system being positioned directly over a surface portion of a micromechanical device.

FIGS. 8A and 8B show an in-plane contact surface and an out-of-plane contact surface respectively.

FIG. 8C shows a cross-sectional view of a portion of a lubricated micromechanical device.

FIGS. 9A and 9B respectively show schematic representations of a perspective view and a top view of a setup to calibrate a lubricant application system according to an embodiment of the invention.

FIGS. 9C and 9D respectively show schematic representations of a perspective view and a top view of lubricating a micromechanical device in accordance to an embodiment of the invention.

FIGS. 9E and 9F respectively show schematic representations of a perspective view and a top view of lubricating a micromechanical device in accordance to an embodiment of the invention.

FIG. 10A shows a schematic of a reciprocating sliding wear test of a device lubricated by a method in accordance to an embodiment of the invention.

FIG. 10B shows a schematic of a custom-made reciprocation sliding tester.

FIG. 11A shows a graph of coefficient of friction (CoF) against sliding cycles for a device lubricated using a method in accordance to an embodiment of the invention.

FIG. 11B shows a graph of CoF against sliding cycles, for a device lubricated using a known dip coating method.

FIG. 11C shows a graph of CoF against sliding cycles for a device lubricated using vapour deposition.

FIGS. 12A and 12B show graphs of CoF for polished and unpolished surfaces respectively.

FIGS. 13A to 13C show optical profiler images.

FIGS. 14A to 14J show optical microscopy images.

FIGS. 15A to 15C show Energy Dispersive Spectrometer (EDS) scans of lubricated Si samples.

FIGS. 16A and 16B show EDS scans of areas of contact not being fully lubricated.

FIG. 17A shows an EDS image for an area near a wear track that has an overflow of lubricant, while FIG. 17B shows an EDS image for an area in the centre of the wear track.

FIGS. 18A to 18D show EDS images of unpolished lubricated Si samples.

FIGS. 19A and 19B respectively show Scanning Electron Microscope (SEM) and EDS images of a polished dip-coated Si surface.

FIG. 20 shows results of an EDS analysis.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

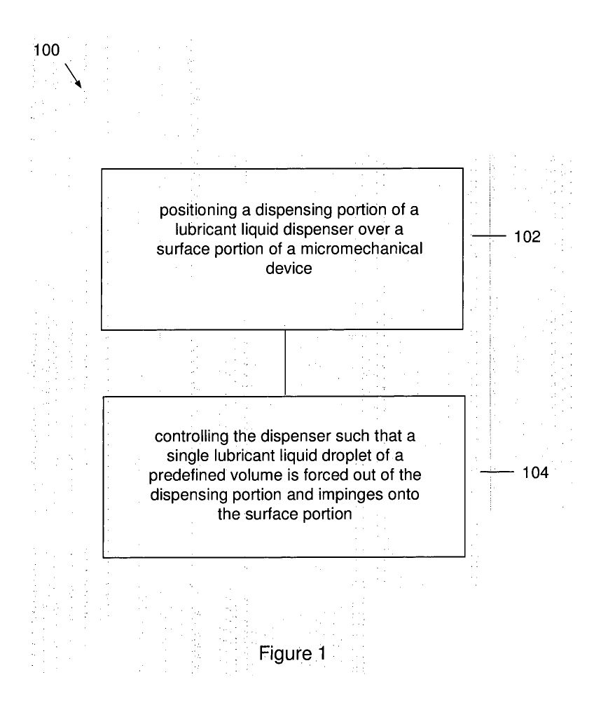

FIG. 1 shows a flow chart 100 illustrating a method, according to one embodiment of the present invention, of applying a: lubricant to a micromechanical device.

The method includes two steps, 102 and 104.

In step 102, a dispensing portion of a lubricant liquid dispenser is positioned over a surface portion of a micromechanical device.

In step 104, the dispenser is controlled such that a single lubricant liquid droplet of a predefined volume is forced out of the dispensing portion and impinges onto the surface portion.

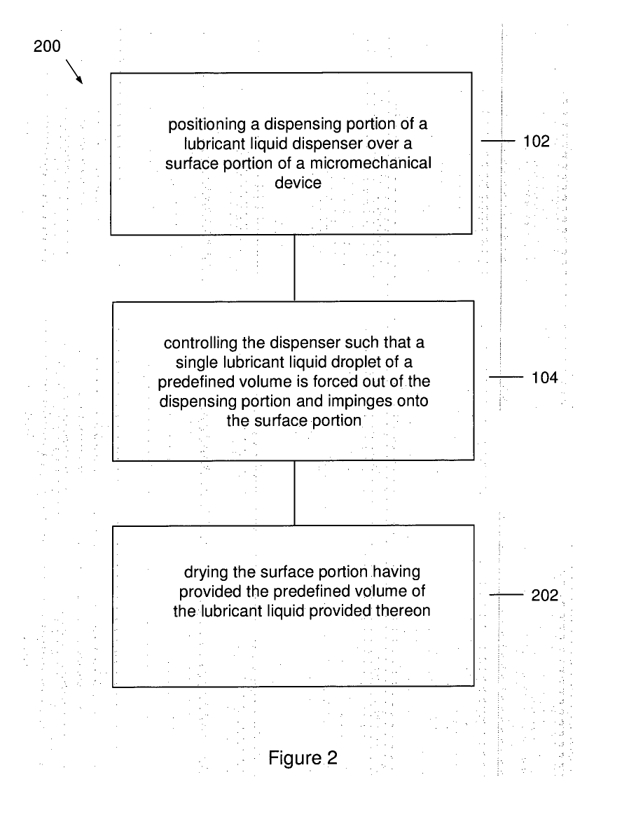

FIG. 2 shows a flow chart 200 illustrating a method, according to one embodiment of the present invention, of applying a lubricant to a micromechanical device.

The method includes three steps, 102, 104 and 202. The first two steps 102 and 104 are the same as the first two steps 102 and 104 of FIG. 1. Thus, steps 102 and 104 of FIG. 2 are not further elaborated.

Upon lubrication (i.e. after steps 102 and 104 are performed), the micromechanical device is preferably dried to avoid solvent viscous forces affecting functionality of the micromechanical device before using or testing of the contact surfaces in movement. It has been found that when PFPE (perfluoropolyether) is used as a lubricant, drying of the applied PFPE allows for physisorption/chemisorption of polymer molecules with a bonded and mobile layer, the combination of which assists lubrication. It has also been observed that drying facilitates self-replenishment of PFPE lubricant molecules.

In step 202, drying of the surface portion of the micromechanical device having the predefined volume of the lubricant liquid provided thereon occurs.

In one embodiment, the drying may be carried out such that lubricant from the lubricant liquid remains on the surface portion after drying the surface portion. In this manner, the solvent in the lubricant liquid evaporates, leaving the lubricant as a coat of dry film on the surface portion of the micromechanical device. The coat may be e.g. around a few nanometers thick (for instance 2-4 nm when using 0.2 wt % PFPE) and preserves the topography and gap allowances between surfaces of the micromechanical device.

In one embodiment, drying may be performed by exposing the surface portion to heat for about between 80° C. and 120° C. for between 30 mins and 1 h.

In another embodiment where no heat is applied, the drying may be performed by exposing, at room temperature, the surface portion for between 36 h and 50 h. Preferably, the drying at room temperature may be performed for between 40 and 48 hours.

In one embodiment where the lubricant liquid constitutes only lubricant in a liquid form, there will be no evaporation of solvent. Rather, drying the surface portion of the micromechanical device serves to cause the lubricant to form a dry film over the surface portion of the micromechanical device.

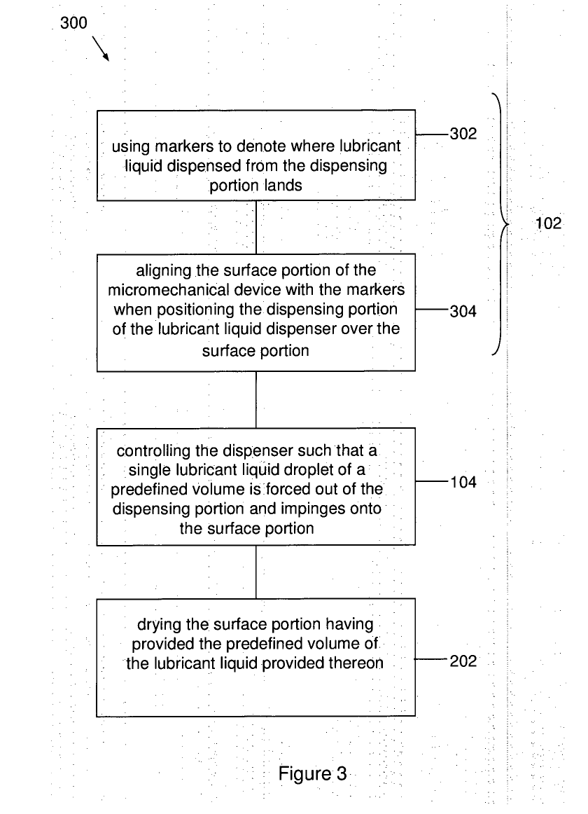

FIG. 3 shows a flow chart 300 illustrating a method, according to one embodiment of the present invention, of applying a lubricant to a micromechanical device.

The method includes four steps, 302, 304, 104 and 202. Step 104 is the same as step 104 of FIG. 1, while step 202 is the same as step 202 of FIG. 2. Thus, steps 104 and 202 of FIG. 3 are not further elaborated.

In step 302, markers are used to denote where lubricant liquid dispensed from the dispensing portion is intended to land.

In step 304, the surface portion of the micromechanical device is aligned with the markers when positioning the dispensing portion of the lubricant liquid dispenser over the surface portion of the micromechanical device.

In step 302, the micromechanical device may not be present when marking where lubricant liquid dispensed from the dispensing portion will land. The lubricant liquid may be applied onto a flat surface instead of a selected gap in the micromechanical device. Step 102 may also further include calibrating the size of the single lubricant liquid droplet such that after the single lubricant liquid droplet impinges on the flat surface, the coat of lubricant liquid formed may have a substantially circular shape with a diameter approximately of not more than 200 μm.

It will be appreciated that, in one embodiment, steps 302 and 304 are sub-steps to the step 102 of the method illustrated in FIG. 1.

Each method of the embodiments illustrated in FIGS. 1 to 3, may include further processing steps (not shown). For instance, before lubricant is applied, the micromechanical device may undergo a plasma treatment. The plasma treatment enhances the surface energy of the micromechanical device to allow the eventually applied lubricant to more readily spread over and bond to the micromechanical device surface. Spread of the lubricant is further facilitated by capillary action on the micromechanical device surface.

Plasma Cleaning may be performed using a “Harrick Plasma Cleaner/Sterilizer” (or other commercially available plasma machines), in which the micromechanical device were exposed to air plasma under vacuum for approximately 5 minutes using an RF power of 30 W.

For other forms of plasma, a vacuum chamber is pumped with a relevant gas while maintaining a minimum vacuum in the chamber. For example, in the case of oxygen plasma, the air in the chamber is first flushed out by vacuum pump and pumping oxygen gas into the chamber at the same time. After 1 minute, the oxygen flow is turned off and a vacuum is attained in the chamber with the micromechanical device. Oxygen gas is pumped into the vacuum chamber at a lower pressure and with the pump running, maintaining the vacuum inside the chamber. The RF is then turned on to the desired wattage, activating the plasma and cleaning/sterilizing/modifying the micromechanical device. The RF switch is then turned off after about 5 minutes, and the chamber aired before removing the samples.

This same procedure can be used for other forms of plasma, simply by interchanging the gas pumped into the chamber at the time of RF activation. For example, in the case of argon plasma, argon gas instead of oxygen would be used. Similarly in the case of air plasma, air from the environment is allowed to flow in instead of oxygen gas.

By implementing any one of the methods illustrated in FIGS. 1 to 3, lubricant (which may be formed as a dry film) will be applied onto a micromechanical device. In one embodiment, the lubricant has a concentration of around 4.0 wt % and includes fluorine present in a general chemical structure as follows:

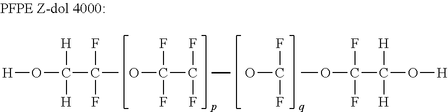

Further detail on the methods illustrated in FIGS. 1 to 3 is provided with reference to an embodiment of a lubricant application system according to an embodiment of the invention.

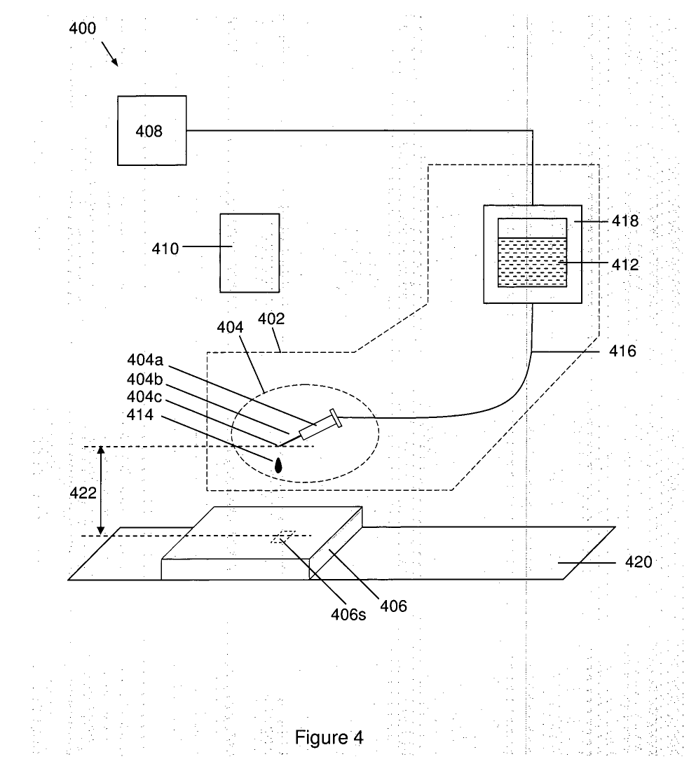

FIG. 4 shows a schematic representation of a lubricant application system 400 according to an embodiment of the invention. The lubricant application system 400 allows for localised dispensation of lubricant onto selected portions of a micromechanical device.

The lubricant application system 400 includes a lubricant liquid dispenser 402, a dispenser controller 408, a microscope 410 and a movable stage 420.

The lubricant liquid dispenser 402 has a dispensing portion 404 and a reservoir 418. The dispensing portion 404 is connected to the reservoir 418 via a tubing 416, the tubing 416 allowing lubricant liquid 412 (stored within the reservoir 418) to flow between the reservoir 418 and the dispensing portion 404. In this manner, the lubricant liquid 412 from the lubricant liquid dispenser 402 is allowed to reach a surface portion 406s of a micromechanical device 406, the micromechanical device 406 being carried by the movable stage 420.

The dispensing portion 404 is configured to be adjustable relative to the surface portion 406s of the micromechanical device 406. The dispenser controller 408 is configured to control the dispenser 402 such that a single lubricant liquid droplet 414 of a predefined volume is forced out of the dispensing portion 404 to impinge onto the surface portion 406s. The dispensing portion 404 has an opening to allow the lubricant liquid 412 from the reservoir 418 to exit.

In one embodiment, the dispenser controller 408 is adapted to apply a pressure force to the lubricant liquid 412 in order to force the single lubricant liquid droplet 414 out of the dispensing portion 404. The dispenser controller 408 is also adapted to apply a vacuum force to the lubricant liquid 412 in order to prevent that, apart from the single lubricant liquid droplet 414, no further lubricant liquid 412 is forced out of the dispensing portion 404. The pressure force may be applied at the reservoir 418 or at the dispensing portion 404 and similarly the vacuum force may bei applied at the reservoir 418 or at the dispensing portion 404. In one embodiment, the dispenser controller 408 may include an air pressure unit.

In one embodiment, the pressure force and the vacuum force is balanced such that the forced out single lubricant liquid droplet 414 having the predefined volume breaks free from the dispensing portion 404 before impinging onto the surface portion 406s of the micromechanical device 406.

By only ejecting a single lubricant liquid droplet from the dispensing portion 404, it is possible to have only a selected surface portion of the micromechanical device impinged by the lubricant liquid 412. The spread of lubricant liquid over the selected surface portion of the micromechanical device 406 is thereby controlled and flooding is minimised. A backflow vacuum, created by the dispenser controller 408, is used to force the single lubricant liquid droplet 414 to break free from the dispensing portion 404. The backflow vacuum applied on the lubricant liquid prevents constant flow of lubricant liquid 412 onto the micromechanical device 406, which is undesired. A net pressure is applied as a shot to eject the lubricant liquid 418 onto the desired location, without suspension of the lubricant liquid 418 from the tip 404c of the dispensing portion 404. At no point of dispensation does the single lubricant liquid droplet 414 contact both the dispensing portion 404 and the micromechanical device 406 at the same time.

Avoiding droplet 414 contact with both the dispensing portion 404 and the micromechanical device is necessary as surface tension and viscous forces of the lubricant liquid are enough to cause a contact component, which has the lubricant liquid thereon, to adhere to the dispensing portion 404 due to the proximity between the dispensing portion 404 and the surface portion 406s. Withdrawal of the dispensing portion 404 may then cause the contacted component to break away from the micromechanical device 406.

In one embodiment, the dispensing portion 404 includes a needle 404b having a needle tip 404c, the opening of the dispensing portion 404 being formed at the needle tip 404c. In one embodiment, the average volume of the single lubricant liquid droplet 414 is around 0.12 μl. In other embodiments, a range of volume of the single lubricant liquid droplet 414 may be approximately between 0.1 μl and 0.2 μl. In one embodiment, the single lubricant liquid droplet 414 may have a spherical shape with a radius of around 0.31 mm.

A channel (not shown for the sake of simplicity) is formed within the needle 404b, the channel guiding lubricant liquid 412 to the needle tip 404c. In one embodiment, a diameter of the lubricant liquid channel at the needle tip 404c is preferably not larger than 80 μm, e.g. may for example range between 60 μm and 80 μm. The lubricant liquid dispenser 402 includes a syringe 404a, the syringe 404a being connected to the needle 404b and connected to the reservoir 418 by the tubing 416.

In one, embodiment, in positioning the dispensing portion 404 of the lubricant liquid dispenser 402 over the surface portion 406s of the micromechanical device 406, it may be the dispensing portion 404 that is moved, while the micromechanical device 406 remains stationary. In another embodiment, in positioning the dispensing portion 404 of the lubricant liquid dispenser 402 over the surface portion 406s of the micromechanical device 406, it may be the micromechanical device 406 that is moved, while the dispensing portion 404 of the lubricant liquid dispenser 402 remains stationary. In another embodiment, in positioning the dispensing portion 404 of the lubricant liquid dispenser 402 over the surface portion 406s of the micromechanical device 406, both the dispensing portion 404 of the lubricant liquid dispenser 402 and the micromechanical device 406 may be moved relative to each other. The movement of the micromechanical device 406 is facilitated by actuating the movable stage 420.

The positioning of the dispensing portion 404 with respect to the surface 406s of the micromechanical device 406 is monitored using the microscope 410 and may be further facilitated through the use of a video imaging system (not shown). In one embodiment, the dispensing portion 404 may be positioned over an actuating portion (not shown for the sake of simplicity) or a gap portion (not shown for the sake of simplicity) of the micromechanical device 406.

In one embodiment, when forcing the lubricant liquid droplet 414 out of the dispensing portion 404, a distance 422 between the dispensing portion 404 (being the needle tip 404c in the embodiment shown in FIG. 4) and the surface 406s of the micromechanical device 406 should preferably be no more than 2 mm, although a range of between 0.5 mm and 3 mm is possible.

In more detail and with reference to the embodiment shown in FIG. 4, the lubricant liquid 412 flows through the channel formed in the needle 404b to be ejected from the needle tip 404c, when pressure is applied to the lubricant liquid 412. After applying a pressure force to the lubricant liquid 412 to force the single lubricant liquid droplet 414 out of the needle tip 404c, a vacuum force may be applied to the lubricant liquid 412 to prevent, apart from the single lubricant liquid droplet 414, no further lubricant liquid being forced out of the needle. The microscope 410 or a video imaging system may be used to monitor the positioning of the needle 404b with respect to the surface 406s of the micromechanical device 406. The distance 422 between the needle tip 404c and the surface 406s of the micromechanical device 406 should preferably be no more than 2 mm, although a range of between 0.5 mm and 3 mm is possible. It will be appreciated that in using a needle, lubrication of the selected surface portion of the micromechanical device can be done in a more precise manner.

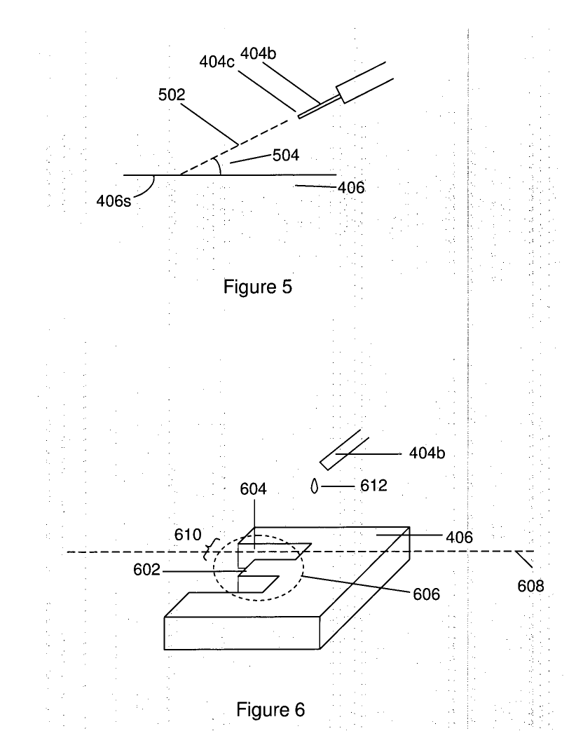

With reference to FIG. 5, a longitudinal axis 502 of the needle 404b is aligned relative to the surface portion 406s of the micromechanical device 406 at an angle 504 ranging between 30° and 90°. Preferably, the angle 504 is around 88° to 92° so that the longitudinal axis 502 of the needle 404b is substantially perpendicular to the surface portion 406s of the micromechanical device 406. In another embodiment, aligning the longitudinal axis 502 of the needle 404b to form an angle 504 of around 45° facilitates easier optical imaging and monitoring of the surface portion 406s being lubricated.

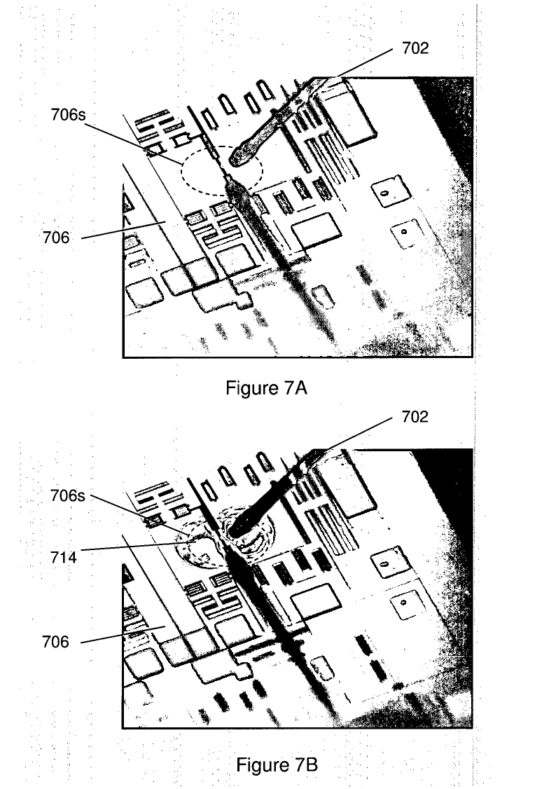

FIG. 6 shows a perspective view of a portion of the micromechanical device 406 of FIG. 4.

From FIG. 6, an actuating portion 602 of the micromechanical device 406 is shown, the actuating portion 602 disposed in an opening 606. The needle 404b should be positioned directly above the point at which contact between the actuating portion 602 and, for example, a sidewall 604 of the opening 606 is expected to take place. The needle 404b should also be positioned parallel to a line 608 of gap 610 between the actuating portion 602 and the sidewall 604. Lubricant 612 can then be applied locally at the desired point of contact along the sidewall 604 and excess spillover of the lubricant 612 can be avoided. Other portions of the micromechanical device 406, such as actuators and comb drives (both not shown), will not be lubricated due to the selective provision of lubricant and their respective functions will therefore not be affected.

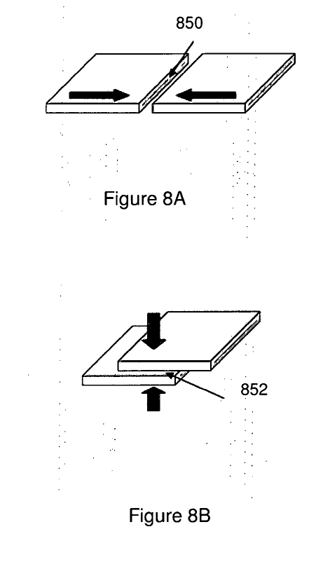

The lubricant 612 travels to the sidewall 604 and the nearby gap 610 in the vicinity of the region where the lubricant 612 is initially applied due to capillary forces. For components within a micromechanical device, typical values for the gap 610 are around 50 to 60 μm. FIGS. 7A and 7B show video snapshots of the operation of a lubricant application system according to an embodiment of the invention.

Both FIGS. 7A and 7B show a needle 702 of the lubricant application system being positioned directly over a surface portion 706s of a micromechanical device 706. In FIG. 7A, lubricant liquid has yet to be ejected by the needle 702 onto the surface portion 706s, while FIG. 7B shows a coat of lubricant liquid 714 applied onto the surface portion 706s.

FIG. 7B illustrates the importance of controlling the volume or size of a single lubricant liquid droplet impinging on the surface portion 706s that forms the coat of lubricant liquid 714, to prevent overflow on the micromechanical device 706 surface. This helps to prevent affecting the actuating or electrical component functionality due to flooding and consequent stiction caused by surface tension upon evaporation of the lubricant liquid. The single lubricant liquid droplet will also need to be of a suitable volume or size as insufficient lubrication may also cause device failure.

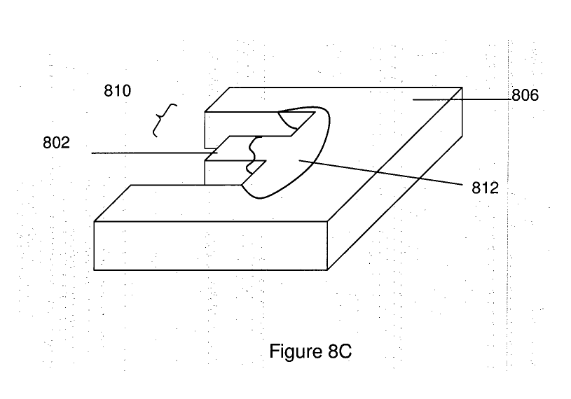

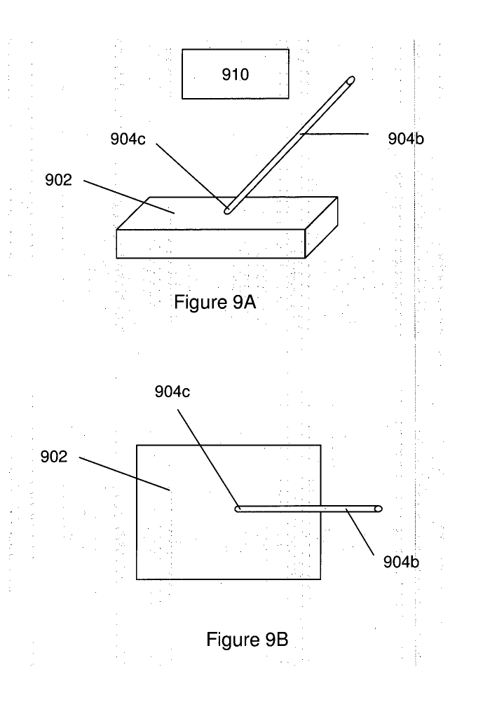

FIGS. 8A and 8B show an in-plane contact surface 850 and an out-of-plane contact surface 852 respectively. It is possible to lubricate the in-plane contact surface 850 or the out-of-plane contact surface 852 by positioning the dispensing portion 404 (see FIG. 4) over either of them.

FIG. 8C shows a cross-sectional view of a portion of a micromechanical device 806 lubricated using a method in accordance to embodiments of the invention.

The micromechanical device 806 includes an actuating portion 802 or a gap portion 810. In the embodiment shown in FIG. 8C, both the actuating portion 802 and the gap portion 810 have a coat of lubricant 812. However, it will be appreciated that, in another embodiment (not shown), the coat of lubricant may be confined to only the actuating portion or only the gap portion.

The coat of lubricant 812 is confined to an area of between 3 mm² and 4 mm² on the surface of the micromechanical device. The area of confinement is preferably restricted to the area of the micromechanical device 806 which is immediately adjacent to either or both of the actuating portion 802 and the gap portion 810. The area of the coat of lubricant 812 depends on how lubricant liquid spreads after impinging on the surface of the micromechanical device 806. For instance, on a flat silicon wafer without surface modification, the lubricant liquid may spread to form a circle of approximately between 1 mm and 2 mm in diameter. The area of the coat of lubricant 812 can be controlled by changing the surface conditions of the device—a more hydrophobic surface would induce a smaller area of spread whereas a more hydrophilic surface would cause a larger area.

The coat of lubricant 812 may include a chemical compound having the following general chemical formulae:

X—CF₂—O—(CF₂—CF₂—O)ₚ—(CF₂O)_{q}—CF₂—X.

As an example, when the lubricant Fomblin Z-dol 4000 is used, the general chemical structure becomes:

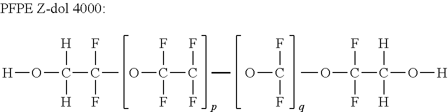

where the p/q ratio is 2/3.

In embodiments of the invention, the concentration of PFPE with solvent that can be used range from 1.0 wt % to 4.0 wt %. The concentration of chemical compounds present within the coat of lubricant 812 can be found through X-ray mapping using Energy Dispersive Spectrometer (EDS) on unmodified surfaces.

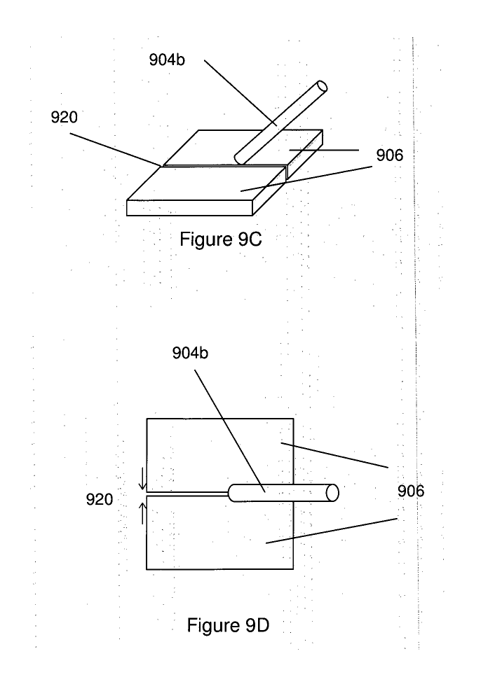

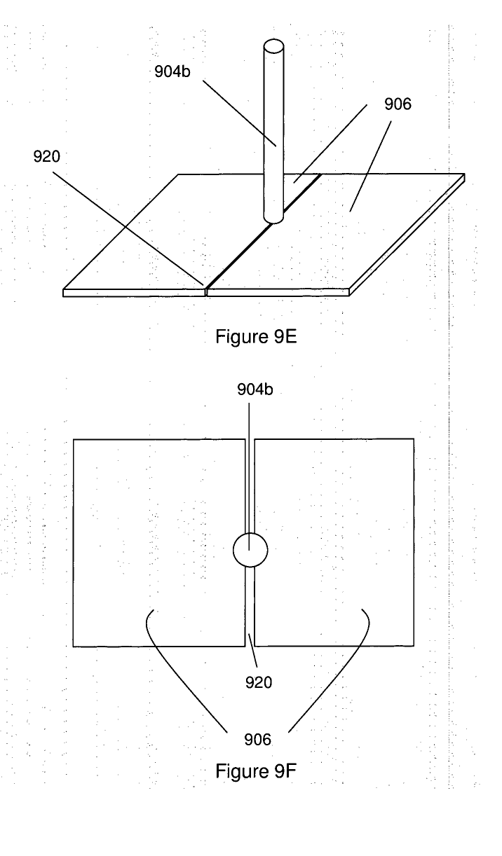

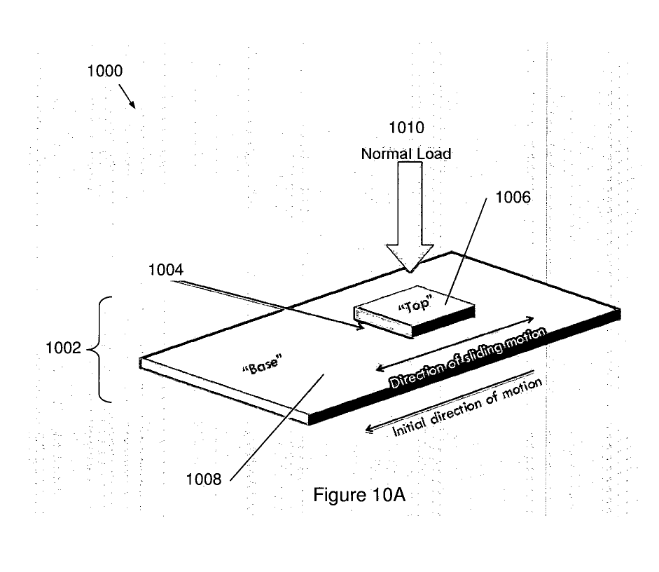

FIGS. 9A to 9F illustrate the processes involved in lubricating micromechanical device in accordance to an embodiment of the invention.

FIGS. 9A and 9B respectively show schematic representations of a perspective view and a top view of a setup to calibrate a lubricant application system according to an embodiment of the invention.

Calibration is carried out to determine and stabilize the following parameters:

(a) Vertical distance of a needle from a micromechanical device to be lubricated
(b) Angle of the needle relative to the surface of the micromechanical device to be lubricated
(c) Horizontal distance of dispensed lubricant from the needle (if the needle is not normal to the micromechanical device surface)
(d) Visual focus of an imaging system monitoring and the calibration substrate/micromechanical device
(e) Volume of lubricant dispensed (which also affects the spread of the lubricant)

Parameters (a) (b) and (c) are controlled via positioning of the needle using a metric stage and holder system. Parameter (d) is controlled using the focus mechanism of the imaging system, and (e) from the control of a pressure/vacuum system.

### Positional Calibration

Turning to FIG. 9A, a calibration silicon substrate 902 is positioned, where the micromechanical device to be lubricated would be placed, under an optical imaging system 910. The calibration substrate 902 is preferably placed on a flat and level surface.

A needle 904b, having lubricant at the desired concentration for use on the micromechanical device to be lubricated, is angled relative to the calibration substrate 902. The needle 904b may have an outer diameter of approximately 80 μm.

After positioning is complete, the imaging system 910 is focused for clear view of both the surface of the calibration substrate 902 and the needle 904b. It should be ensured that there is about 2 mm-4 mm distance between the tip 904c of the needle 904b and the surface of the calibration substrate 902 so as to prevent contact of the lubricant between both the needle 904b and the substrate 902 at the same time to prevent any damage to the micromechanical device to be lubricated.

### Pressure Calibration

Without application of a vacuum to a syringe (not shown) to which the needle 904b is connected, there is a continuous flow of lubricant through the needle 904b due to the lubricant low surface tension and high volatility. A vacuum is applied to limit the continuous flow of lubricant, and the amount of vacuum applied depends on the concentration and viscosity of the lubricant, as well as the inner diameter of the needle 904b used.

The pressure applied to the lubricant by the dispensing mechanism can, be varied according to the size of the lubricant droplet required. A droplet spread size of about 1-2 mm (on a flat unmodified silicon wafer) was found to ensure sufficient lubricant dispensed along the entire sidewall of the micromechanical device to be lubricated. The pressure typically used in the calibration process to force a droplet out of the tip 904c is 80-90 kPa. From a video feed provided by the video imaging system 910, the location (borders) of the droplet spread is noted and the vertices of that location are used as a guide to position the micromechanical device to be lubricated. Care is taken not to move the imaging system 910 or the needle 904b when replacing the calibration substrate 902 with the micromechanical device to be lubricated.

### Actual Device Lubrication

FIGS. 9C and 9D respectively show schematic representations of a perspective view and a top view of lubricating a micromechanical device 906 in accordance to an embodiment of the invention.

A gap 920 of the micromechanical device 906 to be lubricated is positioned in alignment with the vertices located from the calibration process described with reference to FIGS. 9A and 9B. Further, the line of the gap 920 is aligned to be directly below the needle 904b, as shown in FIGS. 9C and 9D. The gap 920 has a width of around 20 to 40 μm.

It will be appreciated that if a different portion of the micromechanical device 906 is to be lubricated, the different portion will be aligned to be directly beneath the needle 904b and aligned to the vertices located from the calibration process described with reference to FIGS. 9A and 9B.

FIGS. 9E and 9F respectively show schematic representations of a perspective view and a top view of lubricating the micromechanical device 906.

Comparing FIGS. 9E and 9F with FIGS. 9C and 9D, the only difference is that the needle 904b has been positioned to be substantially perpendicular to the surface of the micromechanical device 906 (rather than being located, as shown in FIGS. 9C and 9D, at an angle to the surface of the micromechanical device 906). In FIGS. 9E and 9F, the needle 904b is still directly located over the gap 920.

Notwithstanding the chemical substances and process parameters, presented thus far to apply lubricant to a micromechanical device using methods in accordance to embodiments of the invention, a lubricant application system according to an embodiment of the invention may use the following chemical substances and operate under the following parameters.

Pressure applied to lubricant liquid in order to force a single lubricant liquid droplet out onto a surface portion of a micromechanical device may range between 80 and 100 kPa.

A distance between a dispensing portion of the lubricant application system and the surface of the micromechanical device ranges between 0.5 mm and 3 mm. The distance may also be approximately between 2 and 4 mm.

A diameter of the lubricant liquid channel of the dispensing portion of the lubricant application system ranges between 60 μm and 80 μm.

Chemical substances used as lubricant include any one or more of fluorine based nanolubricants, self-assembled monolayers or ionic liquid lubricants. Fluorine based nanolubricants include any one or more of the chemicals fomblin Z, Zdiac, Z-tetraol, pentafluorophenyltriethoxysilane (PFPTES), fluorinert or AZ0H. Self-assembled monolayers include any one or more of the chemicals OTS (octadecyltrichlorosilane) or PFTS (1H,1H,2H,2H-perfluorodecyltrichlorosilane). Ionic liquid lubricants include any one or more of the chemicals penzane 2000 or 1-ethyl-3-hexylimidazolium tetrafluoroborate (L206).

Chemical substances used as solvent include any one or more of H-Galden or toluene.

Drying to remove solvent from the lubricant liquid and leave a dry film of lubricant formed on the surface of the micromechanical device may be performed by exposing the surface portion to heat for about between 30 mins and 1 h and at a temperature of between 80° C. and 120° C. The drying may also be performed by exposing, at room temperature, the surface of the micromechanical device for between 36 h and 50 h and preferably for between 40 and 48 hours.

Further advantages of embodiments of the invention are as follows.

As lubricant is applied locally to the point of contact, no further etching or removal of unwanted layers is required. With localised application of lubricant, actuating and sensing surfaces remain unaffected and fully functional as designed and stiction between these surfaces prevented. If necessary, multiple points of a micromechanical device can be lubricated simply by re-positioning the location of lubrication. Immersion of the micromechanical device is not necessary and the bulk of the device remains unaffected by the lubrication process.

As the method in accordance to embodiments of the invention can be done after micromechanical device fabrication, no modification to the micromechanical device fabrication process is necessary. Should the lubrication be necessary as an intermediate step to the fabrication process, it is easily automated and included within the fabrication process.

No additional packaging needs to be implemented into the fabrication of the MEMS device. By avoiding additional structures or assemblies on the device itself for containment of lubricant or acting as flow boundaries, the method in accordance to embodiments of the invention can be applied on most devices. Without changes to the micromechanical device fabrication process and no packaging requirements for each device, processing costs can be minimised.

### Experimental Results

In substrate level experimental analysis for this invention, an area contact between two Si surfaces were used. It was noted that the lubricant was able to travel significantly far along the gap between the two Si flat pieces due to capillary action.

A lubricant application system according to an embodiment of the invention was tested on a MEMS device with contact components (i.e. components which may have contact with each other) having a gap of around 10 μm when at rest (i.e. even smaller than other typical MEMs devices with component gaps between 50 to 60 μm), well within the range where capillary action readily occurs. The lubricant application system was also tested on a MEMS device with actuating comb drives with gaps in the range of 2 μm apart, where any modification is not desired to maintain the functionality of the device. Even with overflow applied by the lubricant application system, it was noted that the tested devices did not experience a reduction in functionality and without applying a voltage to contact the surfaces together, operated at equal efficiency as unmodified devices.

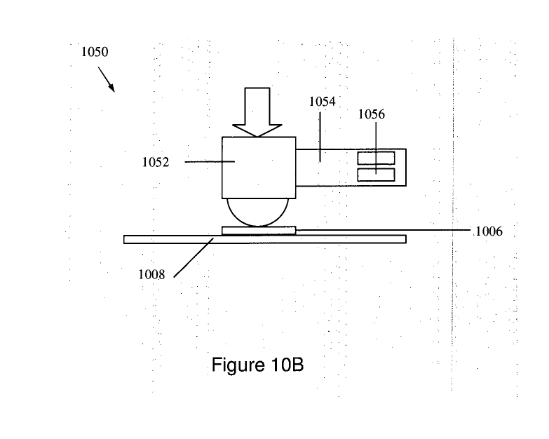

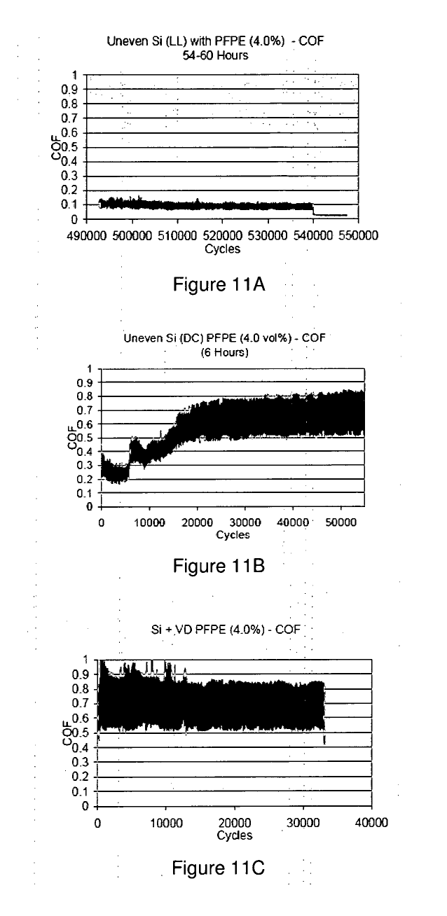

FIG. 10A shows a schematic 1000 of a reciprocating sliding wear test of a device 1002, the sliding wear test used on the device 1002 after lubrication by different methods.

Device 1002 includes an upper piece 1006 with a surface adapted to slide on, or together with, a surface of a bottom piece 1008. The device 1002 was obtained from polished n-type silicon (1 0 0) wafers (obtained from Engage Electronic (Singapore) Pte Ltd), of about 455˜575 μm thickness and with a hardness of 12.4 GPa, substrates. Both the polished and unpolished sides were used in separate tests to investigate differences in texturing. Unpolished sides were also used to approximate the surfaces of unmodified MEMS surfaces and sidewalls, to be compared, with polished Si wafers. The wafers were cut into pieces approximately 1.5 cm by 1.5 cm for the bottom piece 1008, and laser diced into pieces of 2 mm by 2 mm for the upper piece 1006. For the cleaning of each cut Si wafer, the wafers were first washed in ethanol for 1 minute each, followed by ultrasonic cleaning in ethanol for 1 hour. The wafers were then dried in dry N₂ gas, and cleaned with air plasma using a Harrick Plasma Cleaner/Sterilizer, in which the sample surfaces were exposed to air plasma under vacuum for approximately 5 minutes using an RF power of 30 W, before storing in a desiccator while not used.

PFPE (Zdol 4000, molecular weight=4000 g/mol, monodispersed) was used to lubricate the device 1002 surfaces via the following methods:

i) localized lubrication (i.e. in accordance to one embodiment of the invention)
ii) dip coating, and
iii) vapour deposition.
PFPE molecules have terminal OH groups at their ends. The chemical formula of the PFPE used is as follows:

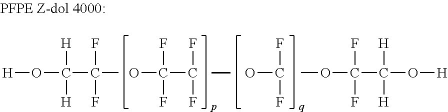

The p/q ratio used was 2/3.

PFPE of all concentrations were prepared in the same way and hydrofluoropolyether solvent (H-Galden ZV) purchased from Ausimont INC was used as the solvent for PFPE. Concentrations used were at 1.0 wt % and 4.0 wt %, with emphasis on the higher concentration.

### i) Localized Lubrication

In accordance with an embodiment of the invention, PFPE lubricant of each concentration was prepared and loaded into a syringe-tube system (not shown). This tubing was attached to a needle at which the lubricant could be locally applied at the interface 1004 between the upper piece 1006 and the bottom piece 1008. The location of the needle and lubricant application was controlled via an X-Y-Z metric stage from Edmund Optics, which enabled controlled movement of the needle/tubing setup in all three axes. The amount of lubricant applied was controlled via a push-dispenser, which releases fixed amounts of lubrication with each dispense. The amount dispensed per release is dependent on the inner diameter of the syringe, which in our study was 1 μl of PFPE lubricant solution per dispense. In each test, 2 μl of PFPE at the respective concentration was applied at the edge of the interface 1004 after the upper piece 1006 and the bottom piece 1008 are brought into contact, and before application of the normal load 1010. The lubricant is believed to spread through the entire interface between the upper piece 1006 and the bottom piece 1008 via capillary action, with the effectiveness being studied by the reciprocating sliding wear test.

### ii) Dip Coating

Dip coating in PFPE was done using a simple dip coating method, with dipping/withdrawal speeds of 2.4 mms⁻¹ and a dipping duration of 1 minute, kept constant for all samples. Dip coating was done after overnight storage in desiccators following the initial air-plasma cleaning. All samples were stored further in desiccators for 1 day for surfaces to stabilize before testing or surface analysis. Only the bottom Si piece 1008 was dip coated due to handling and surface area constraints of the upper piece 1006.

iii) Vapour Deposition

Vapour deposition was done only on polished surfaces by first functionalizing the polished Si surfaces using a Harrick Plasma Cleaner (PDC-32G). The cleaned Si surface was exposed to oxygen plasma under vacuum at 18 W to functionalize the surface. The samples were then inverted over a shallow dish containing the lubricant at the desired concentration, and placed into a vacuum chamber. The setup was left in vacuum chamber for approximately 5 minutes, after which the samples and dish were removed. The presence of PFPE lubricant bonded onto the surface was first verified by EDS analysis and then followed by wear tests.

FIG. 10B shows a schematic 1050 of a custom-made reciprocation sliding tester used to create oscillatory motion for the reciprocating sliding wear test, of FIG. 10A. The two surfaces 1006 and 1008 were placed in contact with each other, and the top piece 1006 attached at its centre to a ball holder 1052, allowing for the application of a normal force at the centre of the upper piece 1006, giving a uniform force across the contact area of the two surfaces. The normal load used was a deadweight load of 50 g attached above the holder so as to ensure the full application of the deadweight normal to the surface. The ball holder 1052 is part of a cantilever 1054, and the oscillatory wear tests were conducted as a flat-on-flat experiment as illustrated in FIG. 10A, with the frictional force continuously measured using four strain gauges 1056 attached to the cantilever 1054. The surfaces 1006 and 1008 were rubbed against each other in oscillatory motion with amplitude of 1 mm in both directions, giving a total movement distance of 2 mm. The sliding velocity of the samples was approximately 5 mms⁻¹ at an oscillating frequency of approximately 2.5 Hz and the sampling rate for recording was at 10 Hz. Tests were done on both polished and unpolished Si surfaces using the reverse side of the wafer, the latter to approximate the surface of MEMS which are deemed to be “rough surfaces”.

The initial coefficient of friction (CoF) was taken from the first 4 seconds, equivalent to the first 10 cycles of the wear test. Samples were considered to have failed when the coefficient of friction (CoF) exceeds 0.3 for a sustained period of time, great fluctuations in the measured CoF were detected, or if wear marks, scratches or debris were visible at the sliding interfaces. The wear life is taken as the number of cycles at which this occurs. Wear tests were first done for 6 hours, and then extended wear tests were done for 60 hours for selected samples and concentrations which showed low coefficients of friction and low amounts of wear after 6 hours. The wear life was determined by performing the tests on at least seven different samples with the same surface modifications and conditions, lubrication and experimental parameters, and taking the average results of at least 10 sets of the most consistent data.

The reciprocating sliding wear test was carried out in a controlled environment at a temperature 25±2° C. and a relative humidity of 55±5%. Both polished and unpolished Si surfaces were used in the wear tests, the latter to simulate a textured effect. Details of application of lubricant remained the same for each method regardless of surface used. Both the top and bottom wafers 1006 and 1008 were cleaned in the same manner.

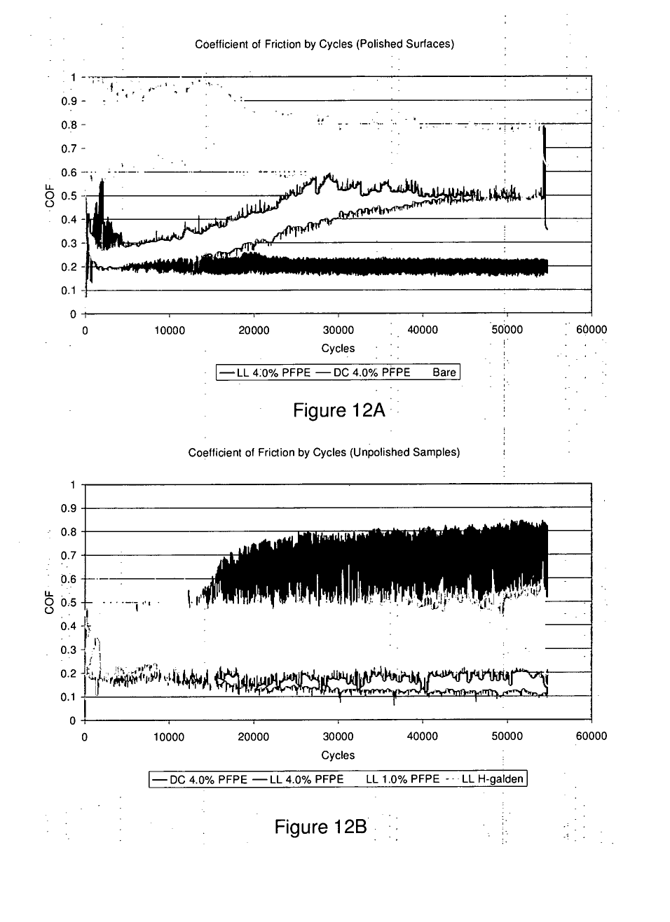

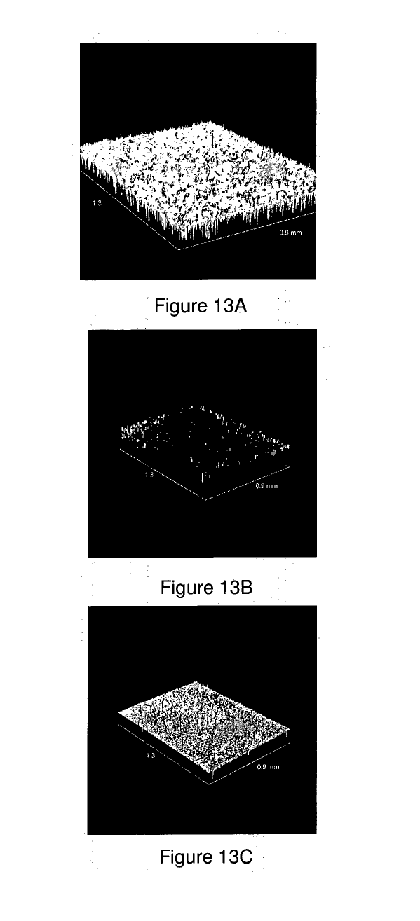

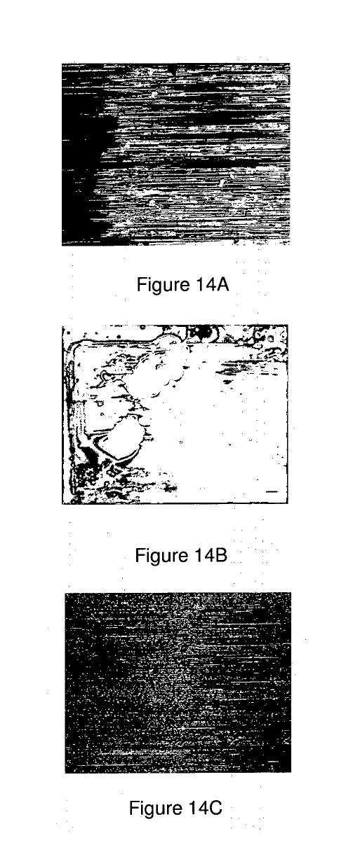

Sliding without lubrication results in massive wear and scratching as well as results in a high coefficient of friction (CoF) and subsequently immediate failure. By applying 4.0 wt % PFPE to the interface 1004 of the device 1002, the result is long wear life and low coefficient of friction even after 60 hours of sliding, as shown in FIG. 11A.

FIG. 11B shows a graph of CoF against sliding cycles, performed for a duration of about 6 hours, for the device 1002 (see FIG. 10A) being lubricated with 4.0 wt % PFPE using a known dip coating method.

FIG. 11C shows a graph of CoF against sliding cycles for the device 1002 (see FIG. 10A) being lubricated with 4.0 wt % PFPE using vapour deposition. Similar results have also been published [“A Nano- to Macroscale Tribological Study of PFTS and TCP Lubricants for Si MEMS Applications” by Miller et. al, Tribol Lett (2010) 38:69-78] on the minimal increase in wear life caused from the addition of PFTS and TCP lubricants as bound and mobile layers respectively, for Si MEMS applications, with experimental devices failing within 100 cycles under those conditions.

Comparing the results shown in FIGS. 11A to 11C, it can be seen that the lubrication method in accordance to an embodiment of the invention produces the best results. It should also be noted that FIG. 11A shows that the device 1002 was subjected to a longer test than those shown in FIGS. 11B and 11C, wherein the CoF for the device 1002 lubricated using a method in accordance to an embodiment of the invention still remained the lowest.

The test shown in FIGS. 10A and 10B was repeated more than seven times to ensure accuracy and the results were found to be consistent over numerous instances and across different batches of sample preparation.

Table 1 below provides a summary of CoF obtained for performing the reciprocating sliding wear test on samples lubricated using the methods mentioned in table 1.

TABLE 1
Summary of CoF for reciprocating sliding wear test

| | | Wear Life | Stable | Initial |
|---|---|---|---|---|
| Surface | Lubricant/Method | (cycles) | CoF | CoF |
| Bare Polished | N.A. | Immediate Failure | — | — |
| Si | | | | |
| Uneven Si | 1.0 wt % PFPE/ | 12,500 | — | 0.45 |
| | localized lubrication | | | |
| Uneven Si | 4.0 wt % PFPE/ | >540,000 | 0.1 | 0.40 |
| | localized lubrication | | | |
| Polished Si | 4.0 wt % PFPE/ | >540,000 | 0.2 | 0.45 |
| | localized lubrication | | | |
| Uneven Si | 4.0 wt % PFPE/Dip- | 6000 | — | 0.40 |
| | Coated | | | |
| Polished Si | 4.0 wt % PFPE/Dip- | 7500 | — | 0.45 |
| | Coated | | | |
| Uneven Si | H-Galden/localized | 50 | — | 0.45 |
| | lubrication | | | |

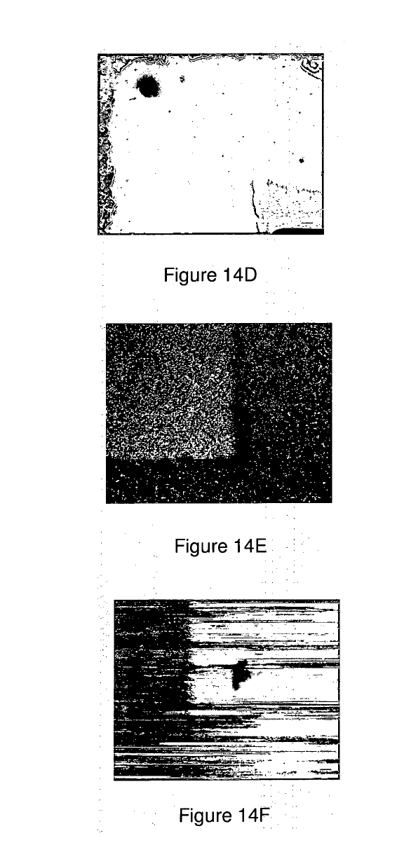

Optimization was first carried out to determine the ideal concentration of lubricant to be used. Reciprocating sliding wear tests at low PFPE concentrations (1.0 wt %) showed little improvement to the wear life between two bare unpolished surfaces. Lubricated samples failed after 12,500 cycles, as compared to non-lubricated surfaces which failed immediately, as seen from FIGS. 12A and 12B. FIGS. 12A and 12B show graphs of CoF for polished and unpolished surfaces respectively.

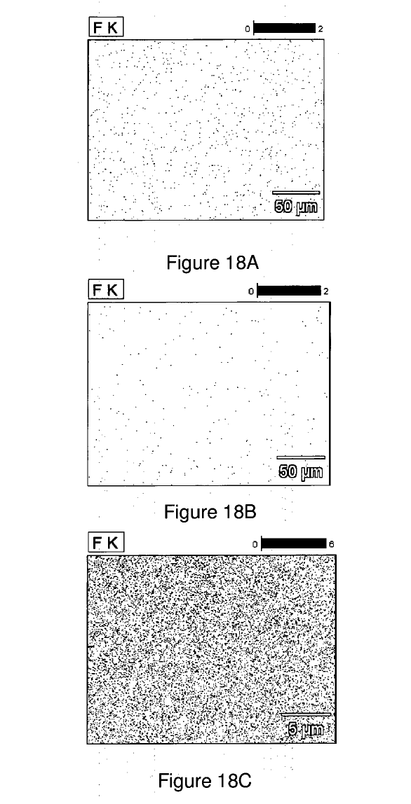

Increased concentration of PFPE was used, to further improve the friction and wear properties. A comparison between 1.0 wt % PFPE and 4.0 wt % PFPE lubricated samples show a significant reduction in CoF and amount of wear debris, as well as longer wear life. With increased concentration of PFPE, there is a higher density of lubricant at the sliding interface, and as such better properties were expected and observed. This is consistent with the friction and wear data and images obtained from surface analysis (see for example, FIGS. 18A to 18D).

On both the polished and unpolished surfaces, higher concentrations of PFPE showed a visible improvement in the wear life and friction properties. At 4.0 wt % concentration of PFPE, the eventual stable CoF measured for reciprocating sliding wear between polished surfaces under localized lubrication was approximately 0.2. The wear life lasted beyond 6 hours and eventually even at 60 hours (540,000 cycles) the samples still did not fail. Initial CoF reduced quickly before failure and scratching/wear of the surface would occur.

For unpolished samples, the CoF was at a steady value of approximately 0.1—a lower value than that observed on polished surfaces—though the initial CoF measured was about the same as the other samples at 0.4, indicating that the surface conditions were the same. Similarly, the high initial CoF dropped rapidly, avoiding any wear or debris formation on the surface, and thus also preventing premature failure. Under the same wear test parameters, 1.0 wt % concentration of PFPE applied with localized lubrication resulted in a stable CoF of 0.2-0.3 and a wear life of 12,500 cycles.

It was discovered that the unpolished surfaces resulted in better friction and wear properties; having a lower CoF during the test and especially for extended wear tests. The initial CoF for the samples upon sliding was also noted to be lower upon the unpolished samples, as compared to the polished samples under the same conditions. This can be seen in the comparison of the CoF over time between the two surfaces illustrated in FIGS. 12A and 12B. Furthermore, separation of the polished surfaces after wear tests required a significant amount of force after the test, indicating that some stiction occurred either during the test or upon lubrication prior to the test, after the solvent has evaporated. This stiction may have been caused by the onset of viscous and surface tension forces from the flow of lubricant through the interface between the two surfaces, leading to adhesion between them.

This presence of stiction is not desirable between the two surfaces as it may cause functionality of the device in application to deteriorate and reusability may be rendered impossible after the onset of stiction. In some cases the stiction was so strong that the two pieces adhered to each other, unable to slide relative to each other for the remainder of the test. Extreme cases of adhesion between the plates caused the glue adhesive between the ball holder 1052 (see FIG. 10B) and the upper piece 1006 to break. This resistance to separation of pieces was not detected or observed in the case of unpolished samples.

The last row of table 1 is a summary of the results of a further experiment to ascertain that lubrication properties came primarily from the application of PFPE and not other related modifications such as H-Galden solvent. The lubricant in the method of “Loc-Lub” was replaced with only the solvent (i.e. H-Galden), and all other experimental parameters were kept constant. As can be seen from Table 1, the rapid failure observed in reciprocating sliding wear shows that H-Galden solvent used alone does not provide sufficient lubrication even though it extends the wear life only slightly and briefly. This verifies that the primary method of lubrication for wear life that lasts a few magnitudes longer comes from the application and presence of PFPE lubricant rather than the H-Galden solvent itself.

A comparison between the different methods of lubrication, using uneven Si surfaces to approximate the surfaces of unpolished MEMS devices, reveals a remarkable improvement in the friction properties between dip-coated and localized lubrication at the same concentration of PFPE applied. Although the initial coefficient is the same, there is a drop in the coefficient for locally lubricated samples compared to the gradual rise in the samples that were dip-coated. This ascertains that localized lubrication (i.e. lubrication in accordance to an embodiment of the invention) is indeed effective at the given concentration in lubricating two surfaces in relative sliding motion.

### Surface Characterization

The surfaces of samples prior to the reciprocating sliding wear test were analyzed using water contact angle measurements and optical profiling whereas surfaces after the reciprocating sliding wear test (FIG. 10A) were analyzed using optical microscopy, FESEM and EDS analysis.

### Water Contact Angle Measurements

VCA Optima Contact Angle System (AST Products, Inc., USA) was used for the measurement of static contact angles of deionized water on unmodified and modified Si surfaces. A 0.5 μl droplet was used for the contact angle measurements, with five to six replicate measurements on the same surface and at least two surfaces of the same modification/surface conditions tested. An exception was made for samples that underwent the localized lubrication method, in which the lubricated area was too small for multiple droplet measurements. In these cases, only one droplet was measured per lubricated sample. The same total number of droplets was still taken albeit across more samples, to ensure accuracy of the measurements. An average value was obtained from all the values, with the variation of measurements on each sample within ±2°. The error for the measurement was within ±1°.

Water contact angles were taken to note the differences in surface condition between method of application and surface roughness, with the results shown in Table 2.

TABLE 2
Water contact angles of different methods of surface modifications

| Surface modification | Water contact angle, ° |
|---|---|
| Polished Si | 5.5 |
| Uneven Si | 5.7 |
| Uneven Si - Localized PFPE (4.0%)* | 38.8 |
| Polished Si - Vapour Deposition (4.0%) | 25.2 |
| Uneven Si - Dip Coat (4.0%) | 30.4 |

*Sample was left for 4 days for H-galden to evaporate.

The changes in water contact angle for dip coated and vapour deposited samples compared to bare Si indicate that the surface had indeed been successfully modified. The change between bare uncoated samples and vapour deposited samples was less significant, possibly due to the low density of PFPE lubricant molecules that are bonded to the surface as later investigated in surface analysis via EDS mapping. Differences between bare uncoated samples and methods of lubrication other than vapour deposition were more significant as the samples had a more dense and uniform distribution of PFPE molecules on the surface. Since PFPE is known to provide a hydrophobic property, it is understandable that the highest density of PFPE on the surface would give the most hydrophobic surface.

Hydrophobic surfaces have been observed to provide better friction and wear properties, and a comparison between the surfaces referred to in Tables 1 and 2 agrees well with this observation. The cause of improved wear life and tribological properties could also be additionally attributed to the concentration and availability of PFPE mobile layer for self-replenishment, so as to continually provide sufficient lubrication at the sliding interface. The texture and roughness of the surface has also been known to change the water contact angles of surfaces, and in this case may also have affected the physisorption of PFPE in the process, hence showing differences between polished and unpolished samples that had undergone the same process.

Dip coated samples were noted to have a slightly larger variation of angles over the same surface at different locations, compared to the samples that were lubricated locally and via vapour deposition. It was observed on polished surfaces under the dip coating lubrication process, that there were dewetting marks on the surface, implying that the PFPE lubrication was not evenly and uniformly spread over the entire surface. The same marks could not be seen on the unpolished surfaces due to the lack of a reflective surface to observe from, though it is likely that the same distribution occurs on the surface as, well. The uneven spreading of PFPE could be due to notably higher concentration used in this process (4.0 wt %) compared to that used in most other research for lubrication of magnetic hard disks (0.2 wt %). The effects and causes of this conglomeration of PFPE droplets on polished surfaces will be later discussed in the effects of texturing.

### Optical Profiling

Optical profiles were taken to investigate the roughness and texture of the various unpolished silicon surfaces. These were taken using a Wkyo NT1100 Optical Profiler with optical phase-shifting and white light scanning interferometry, with non-contact static measurements. The vertical measurement range is between 0.1 nm to 1 mm, with a resolution of less than 1 Å Ra and a vertical scan speed of up to 14.4 μm s⁻¹. Profiles were taken at multiple magnifications of 5, 10, 20 and 50 times, with an integrated stroboscopic illuminator and conducted in a class-100 clean booth.

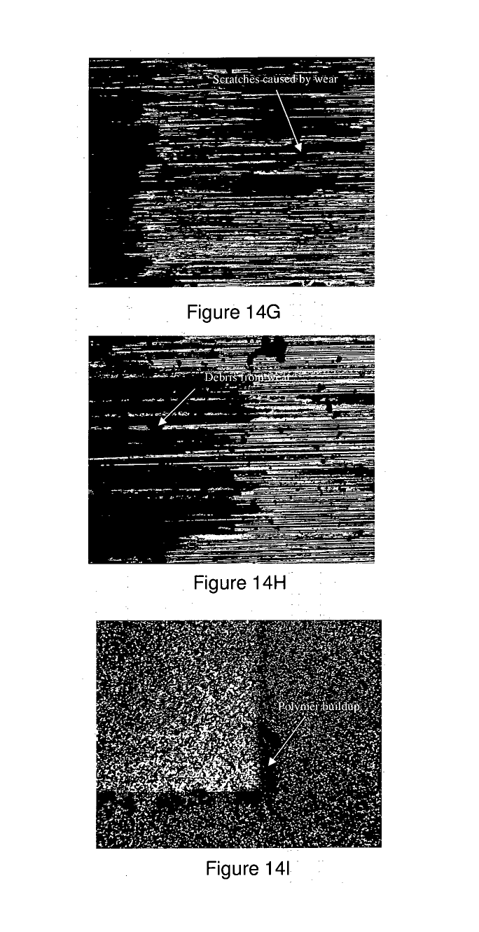

FIGS. 13A to 13C respectively show optical profile images of bare unpolished silicon, dip-coated unpolished silicon and localized lubricated unpolished silicon. These optical profile images show the changes in the surface roughness/topography of the unpolished surfaces after lubrication, where conclusions may be drawn about the behaviour of the lubricant prior to wear testing. The surface roughness of unpolished silicon without any lubrication was Ra=616 nm. Upon dip=coating and localized lubrication, the roughness changed to Ra=812 nm and Ra=415 nm respectively. It is hypothesized that the localized application of PFPE lubricant causes a flooding of the valleys between the asperities, lowering the detectable surface roughness. This would also result in micro-reservoirs of PFPE lubricant readily available across the surface for replenishment, assisting in the self-replenishing properties of PFPE and thereby also improving the wear properties as a result, thus justifying the extended improvement in the wear life of locally lubricated samples, and a lower coefficient of friction for unpolished surfaces compared to polished surfaces.

The roughness of dip coated samples has been noted to increase from the original unlubricated surfaces. It is thought that the method of dip coating ensures that the polymer lubricant stays primarily on the topmost surfaces/points of the substrate, allowing for a downward flow as the substrate is vertically lifted out. The dip-coating method is known to give a uniform film coating over an entire smooth substrate surface—however with a rough surface vertically retracted from the lubricant, it is possible that the method causes the bulk of the polymer lubricant to be physisorbed on the top and sides of asperities, thereby enlarging and extending the asperities, increasing the surface roughness of the substrate. This can be noted from the relatively large variation of water contact angles on the same surface at different points. It is also noted that upon dip coating, the dried surface has “wet” marks on it, with visible dewetting marks. These could also be one of the causes of the increase in roughness values, caused by the higher concentration used as mentioned earlier.

### Optical Microscopy, FESEM and EDS Analysis

Optical microscopy, done after the reciprocating sliding wear test of FIG. 10A, was conducted to analyze the amount of debris and the wear track conditions on the surfaces of the tested samples.

A Leica optical microscope was used to observe the wear track and surface morphology of the samples after the wear tests have been conducted, followed by further investigation on a Field Emission Scanning Electron Microscope (FESEM). FESEM images were taken using a Hitachi S4300 machine coupled with an Energy Dispersive Spectrometer (EDS). EDS surface analysis was conducted on samples both prior to and after lubrication to investigate the distribution and concentration of lubrication on the samples. The same analysis was also done after wear tests were conducted to investigate the effect of the sliding on the distribution and movement of the lubricant applied via the various methods. EDS mapping was also conducted on samples immediately after lubrication and before wear tests to compare the effectiveness and concentration of lubrication methods.

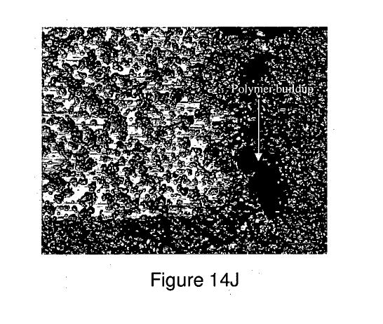

FIGS. 14A to 14F show optical images, taken at 50× magnification, of samples subject to different lubrication methods after 6 hours of the reciprocating sliding wear test of FIG. 10A.

FIG. 14A shows an optical image of polished unlubricated silicon. FIGS. 14B and 14C respectively show optical images of polished and unpolished silicon that have been lubricated using a dip coating method. FIGS. 14D and 14E respectively show optical images of polished and unpolished silicon that have been lubricated using a localised lubrication method (i.e. in accordance to an embodiment of the invention). FIG. 14F shows an optical image of polished silicon that has been lubricated using vapour deposition.

From FIGS. 14A to 14F, it can be seen that there is a different amount of debris formed from applying lubricant using the differing methods.

FIG. 14G (being the same optical image as FIG. 14A, except with a label showing where scratches are formed) and FIG. 14H (being the same optical image as 14A and 14G, but taken at 200× magnification) show that extensive wear, scratches and debris are present on the surface of polished unlubricated silicon.

For FIGS. 14B, D and F (the polished Si surfaces), presence of the polymer lubricant could be observed, under the optical microscope, in the form of diffraction marks similar to oil coatings on surfaces. These were primarily observed along the perimeter of the wear track for samples lubricated in accordance to an embodiment of the invention and on untested areas for dip-coated samples. These observations along with EDS mapping (discussed later) confirm that the lubricant has been partially swept from the wear track to the perimeter during the sliding wear test.

Observable visible differences in the amount of wear debris between different methods of lubricant application were observed in tandem with the improvement of tribological properties observed with the wear tests, as can be seen from FIGS. 14G, 14H, 14I (being the same optical image as FIG. 14E, except with a label showing where polymer buildup occurs) and 14J (being the same optical image as 14E and 14I, but taken at 200× magnification). Scratching was most severe in unlubricated cases (FIGS. 14A, 14G and 14H) and samples lubricated via vapour deposition (FIG. 14F) and were observable with the naked eye. Samples lubricated with vapour deposition were so extensively scratched that there was no observable difference between them and bare Si samples. Dip coated specimens experienced a small amount of scratching, while specimens lubricated in accordance to an embodiment of the invention had no observable scratches found even under optical microscopy. Unpolished Si surfaces experienced the same trend, though a polishing effect was observed in samples lubricated in accordance to an embodiment of the invention. The best tribological properties were observed in unpolished Si surfaces lubricated in accordance to an embodiment of the invention and this was verified under inspection via optical microscopy (see FIGS. 14I and 14J), showing very few scratches and very little wear debris, only a small amount of polymer buildup on the perimeter of the wear tracks.

Scratching occurred when the lubricant film failed, thus exposing the surface to high levels of friction and wear. Lubrication in accordance to an embodiment of the invention was found to be the most effective of the three methods of surface film lubrication, preventing the surface from experiencing excessive wear. Unpolished surfaces were noted to have fewer asperities on the wear track than before, due to the aforementioned polishing effect, with no detrimental effect on the coefficient of friction experienced during the reciprocating sliding wear test.

### FESEM/EDS Mapping

The different methods of lubrication are thought to produce different distributions and bonding of lubrication across the surface.

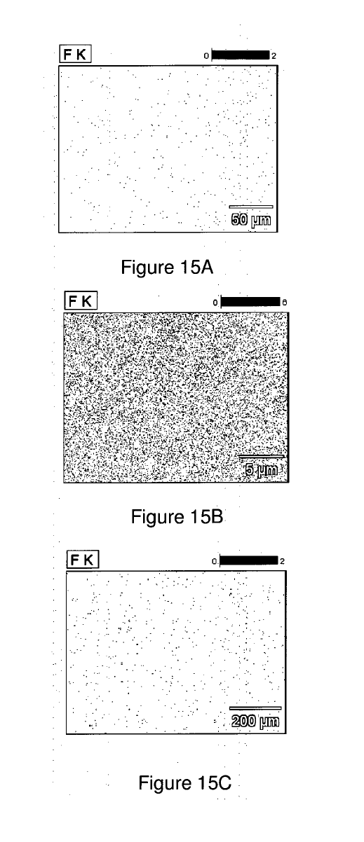

FIG. 15A shows an EDS scan of a Si sample lubricated using a dip coating method. FIG. 15B shows an EDS scan of a Si sample lubricated using a localised lubrication method (i.e. in accordance to an embodiment of the invention). FIG. 15C shows an EDS scan of a Si sample lubricated using vapour deposition.

FIGS. 15A to 15C provide a comparison of the effects of method on the distribution of the lubricant, and subsequently the correlation to the tribological properties.

Comparing FIGS. 15A to 15C, the density of the element fluorine (F), which is indicative of the PFPE lubricant, is highest for the localised lubrication method (see FIG. 15B). Vapour deposition lubricated specimens (see FIG. 15C) show the next highest F concentration, although the lubricant is noted to be distributed visibly more sparsely over the entire surface. Dip-coated specimens (see FIG. 15A) show an overall presence of lubricant on the substrate—however, the concentration was noted to be the lowest among the three specimens. No traces of F are found on non-lubricated samples (not shown). All lubricant used in this comparison was kept at 4.0 wt % concentration for consistency in comparison in the effects of the method of lubrication and their effects on the tribological properties of the surface.

The concentration of lubricant found on the surface is clearly a factor in the tribological properties of the surface—all surfaces with detectable levels of fluorine have a longer wear life than that of bare Si surfaces, and the surface with the highest concentration noted (those under localized lubrication) also had the longest wear life with the lowest coefficient of friction. The concentration of the lubricant found on the surface is then found to be directly positively related to the wear life and the friction properties of the surface.

However, the bonding mechanism and the type of bonding between the lubricant and the substrate is also a huge determinant. Although dip-coating shows less PFPE lubricant on the surface that samples lubricated by vapour deposition, it has also been shown to have a longer wear life than the latter. This is possibly due to the presence of both the mobile and bonded phases of PFPE on the surface for dip-coated specimens, providing good friction properties. However, in the case of vapour deposition lubricated samples, due to the functionalized surface from the oxygen plasma treatment and the technique of lubrication of the surface, only the bonded phase is present on the surface—this has been noted to give poor friction and tribological properties.

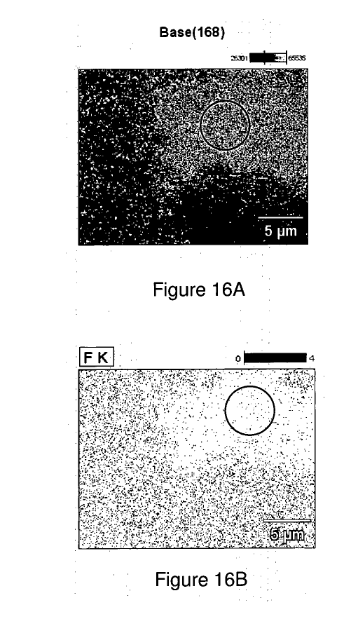

EDS was also carried out to observe the concentration profile across different locations on the surface after lubrication in a method in accordance to an embodiment of the invention and prior to wear testing. It was found that small areas between the surfaces in contact were not lubricated uniformly via capillary forces and hence there was an area between the two pieces which was not completely lubricated. This area, as circled in FIGS. 16A and 16B, would typically be in the length of approximately 15 μm.

Comparing F concentrations at three points; the middle of the contact between samples, at the visibly lubricated areas around the contact area, and at a point located far away from the lubrication where no lubricant was deemed to have reached, the highest F concentration was found at the visibly lubricated areas around the contacting surfaces, followed by the area in the middle and lastly no traces of F at the areas far away from the location of application of lubricant.

This concentration profile explains the initial relatively high CoF for lubricated samples, as a small area between the surfaces are only mildly lubricated. However, due to the nature of PFPE lubricants, it is expected that upon reciprocal sliding the mobile or liquid layer will enter the dry zone, leading to lowering of the friction coefficient before the onset of wear and third body abrasion can take place, as in the case of bare Si on Si sliding. Furthermore, the quick decrease in CoF due to this quick inflow and replenishment of PFPE to the wear area is immediate enough to prevent any wear or scratching from occurring. In addition to that, it was noted if the lubricant is locally applied and left to rest for a short period of a few minutes, the lubricant concentration profile at the centre eventually becomes the same as that in FIG. 15B, thus lubricating any initially unlubricated surface.

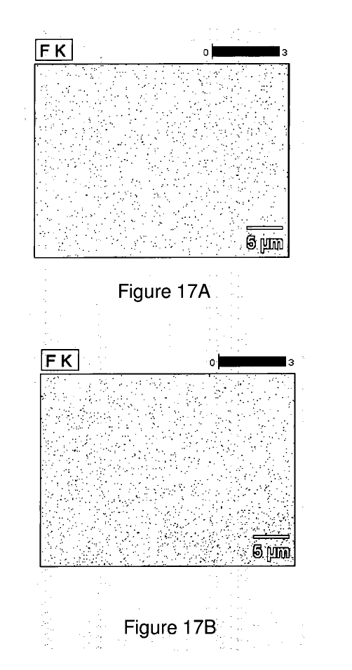

EDS mapping done after performing the reciprocating sliding wear test of FIG. 10A indicates a strong presence of PFPE on the wear track even after 540,000 cycles (see FIGS. 17A and 17B). FIG. 17A shows an EDS image for an area near a wear track that has an overflow of lubricant, while FIG. 17B shows an EDS image for an area in the centre of the wear track, both images taken after 540,000 cycles.

A high concentration of PFPE lubricant detected on the wear track confirms the lubricant still protects the surfaces in contact during the sliding motion and therefore results in low CoF and low wear as observed. The highest concentration was noted on the wear track surface, due to the direct application to that area prior to the wear track. The retention of the high concentration even after the wear test could be due to the self-replenishing properties of PFPE, especially on the asperities of the uneven Si samples. The area which had some overflow of lubricant during localized application were also noted to have high levels of lubricant detected, providing a source for the self-replenishment effect to occur from.

FIGS. 18A and 18B respectively show EDS images for unpolished dip-coated Si samples before and after conducting the reciprocating sliding wear test of FIG. 10A for 6 hours. FIGS. 18C and 18D respectively show EDS images for unpolished Si samples, lubricated in accordance to an embodiment of the invention, before and after conducting the reciprocating sliding wear test of FIG. 10A for 6 hours.

Dip coated samples showed a much lower level of PFPE present on the wear track after 6 hours of wear test. Given that the initial amount of PFPE detected on the surface was much lower for dip-coated samples than samples lubricated in accordance to an embodiment of the invention, it is expected that the replenishment of lubricant in the sliding region would not be as concentrated nor would there be continued replenishment for as long a period of time due to the lack of availability of lubricant for replenishment action. It is also possible that the textured surfaces contained small reservoirs of mobile PFPE within the valleys of the asperities which is used in the replenishment process for the asperities in contact, thus preventing wear. This is evidenced in the sustained presence of PFPE detected on the wear track for samples lubricated in accordance to an embodiment of the invention (see FIG. 18D), but a drop in the level of PFPE detected on the wear track for dip-coated samples (see FIG. 18B). Though both wear tracks show a drop in the level of PFPE lubricant detected, there is still sufficient PFPE at the wear interface to prevent wear and high levels of friction.

### Effects of Texture Differences

The experimental results discussed thus far show that unpolished lubricated in accordance to an embodiment of the invention, using 4.0 wt % PFPE, give the lowest coefficient of friction and the longest wear life. Stiction when separating the surfaces after lubrication in accordance to an embodiment of the invention and wear testing is only observed in the separation of the polished surfaces and not in that of the unpolished surfaces. Investigation was carried out to understand the mechanism and how the different textures help improve the tribological properties. Texturing to modify surface properties is thought to reduce stiction, friction and wear, in MEMS devices.

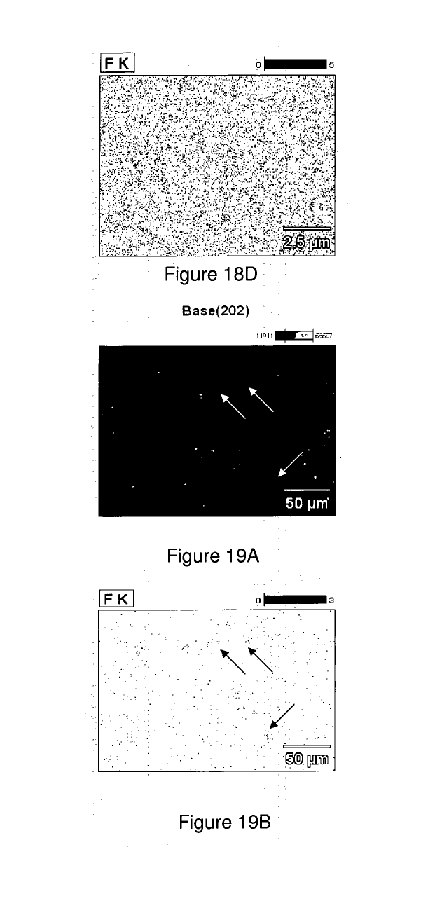

It was noted that there was a conglomeration of droplets of PFPE on polished dip-coated samples, leaving dewetting marks and microdroplets on the polished surface. FIGS. 19A and 19B respectively show SEM (Scanning Electron Microscope) and EDS images of a polished dip-coated Si surface, where droplets of PFPE (indicated by the arrows) were detected on the surface after the solvent has evaporated. The distribution of PFPE was also non-uniform as a result. It is possible that because the polished surface has extremely low roughness, the relatively high concentration of PFPE (4.0 wt %) forms droplets on the surface as the solvent evaporates and agglomerates together. Agglomeration is prevented from occurring in the unpolished surface as the lubricant solution sinks into the valleys between the asperities, causing a more uniform distribution over the surface as the solvent evaporates, as the polymer is unable to agglomerate over the surface.

Texturing should not only provides a lower real contact area, thereby reducing stiction, but also could physically act as a temporary reservoir or storage for the lubricant, allowing for easier replenishment. It has been shown that PFPE lubricants show good friction and wear characteristics when both the bonded and mobile layer are present, and has no remarkable improvement when only the bonded layer is present. EDS scans on polished samples and unpolished samples after 6 hours of reciprocating sliding wear reveal that a greater amount of PFPE was detected on the surface of the unpolished sample after testing, implying that the texturing also allows for more effective replenishment and therefore lubrication of the sliding surfaces compared to the polished surfaces.

The uneven surface may prevent excessive sweeping of the lubricant to the edges of the wear track, allowing for an extended wear life. EDS scans on locally lubricated samples of both surfaces show similar levels and concentrations of PFPE lubricant on the surface, indicating that the changes in the lubricant levels are caused during the reciprocating sliding wear test. The decrease in the levels of PFPE detected after the wear tests is more obvious in the case of polished silicon, possibly because the flat surface provides no enclaves in which the lubricant can avoid being ploughed to the sides of the wear track and is therefore forcefully removed from the surface as can be observed in the polymer buildup around the sides of the wear track. This removes the mobile layer of PFPE and the lubricant's effectiveness is greatly decreased as the bonded layer of PFPE has been proven to be ineffective in preventing wear.

In addition, the polishing effect (as described earlier with reference to FIG. 14E), observed under optical microscopy for unpolished surfaces, lubricated in accordance to an embodiment of the invention, removes asperities. The mobile layer which was previously trapped is now able to move smoothly over the newly exposed surface, allowing for the self-replenishment of the film to occur. This prevents the smoothened surface from excessive scratching and thereby prevents failure of the surface. As a result of the combination of these effects; the unpolished surfaces show better friction properties than the polished surfaces as they allow for pockets of lubricant to be stored and accessible for easy replenishment, showing less signs of debris and wear after the reciprocating sliding wear tests have been conducted.

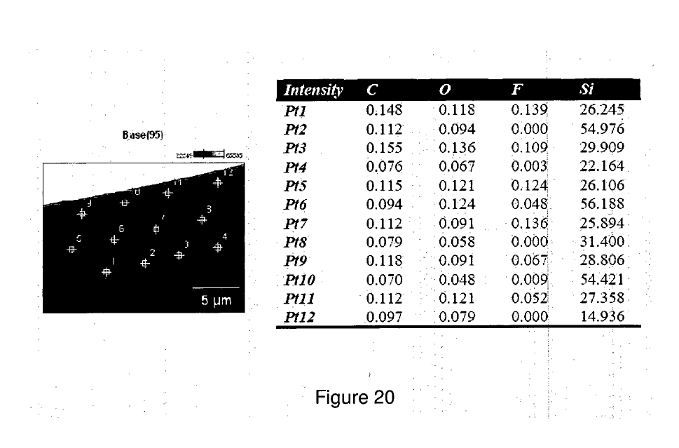

To confirm that lubricant modified a sidewall surface, a device lubricated by a method in accordance to an embodiment of the invention was broken sidewall of the component. Energy Dispersive Spectroscopy (EDS) analysis was done to determine the elements on the surface. Fluorine has been known to be representative of the lubricant PFPE and was found on the side wall surface. Due to the low thickness of the lubricant film, the element was not always be detected in the same amounts. However, in comparison to uncoated surfaces where no trace amounts could be found, it can be concluded that the sidewall was indeed lubricated due to capillary action. FIG. 20 shows the results of the EDS analysis.

Stiction analysis (not shown) was performed on side-walls before and after they were lubricated by a method in accordance to an embodiment of the invention. Additional effects on the stiction between components were observed after lubrication on device. Prior to lubrication, when the two surfaces of the fabricated device were contacted with the increase in actuating voltage, stiction occurred between the contacts and a voltage with reverse polarity had to be applied on the device to pull the two surfaces apart. This applied voltage was calculated to be approximately 240 μN in force to pull the contacted surfaces apart, inclusive of the spring force. After lubrication however, the surfaces separated upon merely lowering of the voltage from 110 V to 100 V, which approximates the new stiction force to be only around 32 μN, evidencing that the surface had been modified and successfully reduced the stiction between the two surfaces to the point that they can be separated easily without any additional force.

### Conclusion of Experimental Results

Performing lubrication in accordance to embodiments of the invention provide adequate lubrication for long term usage between Si surfaces experiencing reciprocating sliding wear, and has proven to be better than that of dip-coating in the same concentration. The local application of lubrication to the point of wear prevents surface modification on the entire surface and can be adapted to use on devices to which the bulk surface of the system has to remain unmodified to retain functionality. This is particularly useful for MEMS devices and their sidewalls in which only a local application of lubrication is desired in order to retain the functionality of the entire device.

The self-replenishment mechanism of PFPE lubricants is theoretically not applicable in the vapour deposition method due to the absence of a mobile layer, and the bonded layer provides insufficient lubrication for the prevention of, wear. Similarly, self-replenishment for surfaces under dip-coating of PFPE lubricant experience inadequate replenishment for protection of the surface. Although reciprocating sliding wear is thought to assist self-replenishment of the PFPE film, only Si surfaces lubricated in accordance to an embodiment of the invention show more evidence of substantial and effective self-replenishment due to the abundant availability of mobile PFPE in the surrounding area of the wear track.

Rough unpolished surfaces give better properties than polished surfaces, primarily due to the onset of stiction caused by the viscous and surface tension forces, and have shown less adhesion between contacting surfaces. Replenishment is also thought to be easier due to the “valleys” in the unpolished surfaces which allow for storage of the lubricant, increasing the wear life of the surface.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of applying a lubricant to a micromechanical device, the method comprising:
positioning a dispensing portion of a lubricant liquid dispenser over a surface portion of a micromechanical device; and
controlling the dispenser such that a single lubricant liquid droplet of a predefined volume is forced out of the dispensing portion and impinges onto the surface portion.

2. The method according to claim 1,
wherein pressure applied to the lubricant liquid in order to force the single lubricant liquid droplet out of the dispensing portion ranges between 0.08 MPa and 0.1 MPa.

3. The method according to claim 2, wherein the pressure applied to the lubricant liquid is from a shot of air.

4. The method according to claim 1,
wherein, after having applied a pressure force to the lubricant liquid in order to force the single lubricant liquid droplet out of the dispensing portion, a vacuum force is applied to the lubricant liquid in order to prevent that, apart from the single lubricant liquid droplet, no further lubricant liquid is forced out of the dispensing portion.

5. The method according to claim 1,
wherein the positioning of the dispensing portion with respect to the surface of the micromechanical device is monitored using a microscope.

6. (canceled)

7. The method according to claim 1,
wherein the dispensing portion comprises a needle having a needle tip, wherein lubricant liquid is guided to the needle tip through a lubricant liquid channel formed within the needle.

8.-17. (canceled)

18. The method according to claim 1,
wherein the dispensing portion of the lubricant liquid dispenser is positioned over an actuating portion or a gap portion of the micromechanical device.

19. The method according to claim 1,
further comprising drying the surface portion having the predefined volume of the lubricant liquid provided thereon.

20. The method according to claim 19,
wherein the drying is carried out such that lubricant from the lubricant liquid remains on the surface portion after drying the surface portion.

21.-24. (canceled)

25. The method according to claim 4,
wherein the pressure force and the vacuum force are applied such that a single lubricant liquid droplet having the predefined volume breaks free from the dispensing portion before impinging onto the surface portion of the micromechanical device.

26. The method according to claim 1,
further comprising using markers to denote where lubricant liquid dispensed from the dispensing portion lands; and
aligning the surface portion of the micromechanical device with the markers when positioning the dispensing portion of the lubricant liquid dispenser over the surface portion of the micromechanical device.

27. A lubricant application system comprising:
a lubricant liquid dispenser having a dispensing portion configured to be adjustable relative to a surface portion of a micromechanical device;
a dispenser controller configured to control the dispenser such that a single lubricant liquid droplet of a predefined volume is forced out of the dispensing portion to impinge onto the surface portion.

28. The lubricant application system according to claim 27,
wherein the dispenser controller is adapted to apply a pressure force to the lubricant liquid in order to force the single lubricant liquid droplet out of the dispensing portion;
and adapted to apply a vacuum force to the lubricant liquid in order to prevent that, apart from the single lubricant liquid droplet, no further lubricant liquid is forced out of the dispensing portion.

29. The lubricant application system according to claim 28,
wherein the pressure force and the vacuum force are balanced such that the forced out single lubricant liquid droplet having the predefined volume breaks free from the dispensing portion before impinging onto the surface portion of the micromechanical device.

30. The lubricant application system according to claim 27,
further comprising a microscope to monitor the positioning of the dispensing portion with respect to the surface of the micromechanical device.

31. The lubricant application system according to claim 27,
wherein the dispensing portion comprises
a needle having a needle tip; and
a lubricant liquid channel formed within the needle to guide the lubricant liquid to the needle tip.

32. (canceled)

33. The lubricant application system according to claim 27,
wherein the dispenser controller comprises an air pressure unit.

34. The lubricant application system according to claim 27, further comprising a movable stage to carry the micromechanical device.

35. A micromechanical device comprising lubricant applied using the method in accordance to claim 1.

36. (canceled)

37. A micromechanical device comprising
an actuating portion; or
a gap portion,
the actuating portion or the gap portion having a coat of lubricant, the coat of lubricant confined to an area of between 3 mm² and 4 mm² on the surface of the micromechanical device.
